(19) United States
(12) Patent Application Publication
(10) Pub. No.: US 2026/0318274 A1
(43) Pub. Date: Oct. 15, 2026

(54) FLEXIBLE OSCILLATING WATER COLUMN

(71) Applicant: PEAK LLC, AMES, IA (US)

(72) Inventors: Ossama Omar Abdelkhalik, Ames, IA (US); Paul Koola, La Marque, TX (US)

(21) Appl. No.: 19/646,878

(22) Filed: Apr. 14, 2026

Related U.S. Application Data
(60) Provisional application No. 63/788,422, filed on Apr. 14, 2025.

(51) Int. Cl. F03B 13/14

(52) U.S. Cl. CPC F03B 13/142

(57) ABSTRACT

A flexible oscillating water column is a device that improves oscillating water column technology through use of a flexible material with advanced controls to convert energy content in ocean waves to electric power. The flexible oscillating water column is integrated in coastal structures such as break waters. As water waves rise inside a chamber, the air flows into a turbine to generate electricity. The flexible oscillating water column reduces the cost of electricity. The flexible oscillating water column adds sea waves to the portfolio of energy resources, increasing stability and resilience of electric grids.

### CROSS REFERENCE TO RELATED APPLICATIONS

This application claims priority under 35 U.S.C. § 119(e) to provisional patent application U.S. Ser. No. 63/788,422, filed Apr. 14, 2025. The provisional patent application is hereby incorporated by reference in its entirety herein, including without limitation: the specification, claims, and abstract, as well as any figures, tables, appendices, or drawings thereof.

### STATEMENT REGARDING FEDERALLY SPONSORED RESEARCH OR DEVELOPMENT

This invention was made with government support under Grant No. DE-SC0025144 awarded by the United States Department of Energy. The government has certain rights in the invention.

### TECHNICAL FIELD

The present disclosure relates generally to green energy source and/or corresponding method of generating renewable energy, having applications in at least the energy sector. More particularly, but not exclusively, the present disclosure relates to a flexible oscillating water column that can integrate into coastal structures, such as breakwaters.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

### INTRODUCTION

The population of the earth is growing exponentially. The population has recently crossed eight billion people and projections suggest the population may even approach ten billion people. Humans are insignificant compared to the size of the planet. However collectively, humans have been able to alter many of the planet's ecosystems, thereby triggering the Anthropocene age. As the population grows, the energy required and consumed by humans also grows. Sustaining this high demand using polluting and fixed resource fossil fuels is not a viable long-term option. Hence, a mix of renewable energy and non-renewable energy has been advocated for a long time.

Ocean wave energy is an abundant source of renewable energy. The present disclosure addresses a small part of how this resource could be used economically. Sustained funding for wave energy in the United States has been made available only in recent decades. The goal of the present disclosure is to take concrete steps to ensure the success for commercially implementing ocean wave energy in a scientific and systematic manner based on the past experiences in designing, building and testing a one hundred fifty kilowatts (150 KW) wave energy full scale prototype, pumping electricity to the national grid.

Solar energy impinging on the earth's surface causes temperature gradients due to the earth being spherical, rotating on its inclined axis and revolving around the sun. These temperature gradients cause winds which when blowing over the ocean surface transfer their energy to produce waves. These waves then propagate over very long distances to reach the shoreline where they transfer their energy by breaking on the beaches converting rocks to sand over millennia. The potential global energy production from waves is estimated to amount to thirty two thousand terrawatts (32,000 TWh) of electricity. Mørk, G., S. Barstow, M. T. Pontes, and A. Kabuth. June 2010. “Assessing the global wave energy potential.” In 29th International Conference on Ocean, Offshore Mechanics and Arctic Engineering. Shanghai, China: Proceedings of OMAE 2010 (ASME).

It has also been estimated that global offshore wave power levels close to the coastline where most of humanity resides at an annual average power level of ten kilowatts per meter (10 kW/m). See e.g., Cornett, A. M. July 2008. “A global wave energy resource assessment.” In: Proceedings of the Eighteenth. Vancouver, BC, Canada: International Society of Offshore and Polar Engineers. 318-326. The present disclosure focuses on coastal wave energy and not the deep-water high-energy resource that is of an order of magnitude greater: about one hundred kilowatts per meter (100 kW/m).

After the first oil crisis in 1974, wave energy technologies started to be developed mainly in Europe, and Japan. The United States was late to adopt wave energy technologies but is making great strides with substantial funding through Department of Energy programs and the federal labs supporting an ecosystem of growth across the population to make the entire technology pipeline sustainable. Currently, wave energy research is almost global with various device concepts being tested around the world. To understand how one extracts energy from waves, one is benefitted greatly by having a thorough understanding of water waves.

### Ocean Waves

Waves are formed by winds blowing over the surface of large bodies of water like oceans or lakes. Winds typically blow for days to weeks over thousands of kilometers in the deep ocean on the water surface generating waves. As the wind keeps blowing on the water surface the water surface at first forms ripples and energy is transferred from the wind to the water due to wind shear. As the ripples grow into larger waves, the wind can transfer more energy due to the larger surface irregularity of the water surface and this process continues until no more energy can be transferred to the wave for the characteristic dimensions of the wave. This is when one sees white caps: i.e., when the wave is saturated for the given wavelength, and wave height can no longer increase. Wave height and length determine the amount of energy carried in a wave. When the wave height to wavelength ratio exceeds 1:7, waves tend to break. Water particles at the crest of the wave travel faster than the wave speed and are taken out of the water body and break to form white caps. In general, as more and more energy is transferred from the wind to the waves, the waves become longer and higher. The regions where winds blow over the ocean surface while transferring their energy to the water are called seas. When these waves keep travelling out of the wind zone, they travel towards the coastline almost unhindered and with very little loss of energy bringing all the collected wind energy in the form of ocean waves to the coastline. These waves when they travel outside the wind zone are called swells.

Unlike electromagnetic and acoustic waves, water waves are dispersive. This means that longer waves travel faster than shorter waves. As the waves developed in the deep ocean travel towards the coastlines the longer waves overtake the shorter waves, and long swells come into coastlines like in the California coast from the Pacific Ocean. As discussed, ocean waves have different wave lengths (frequencies) and amplitudes and even directions. Understanding the properties of a wave like the wave amplitude, period, and direction is very important to be able to design efficient wave energy devices. These variations are represented in a directional wave spectrum. However, due to wave refraction close to the coast, waves impinge on the coastlines almost normally. This means that the change in wave direction at the coastlines is not as much as in the deep ocean.

Wave oscillations are a maximum at the surface and decay exponentially down to the bottom. Waves are also classified as deep water and shallow water comparing the wavelength to the water depth at that location. Deep water waves are at locations where the water depth is greater than one half of the wavelength. Intermediate or shallow water waves affect coastal structures. In shallow waters the wavelength is compressed, and the wave heights are increased, and this phenomenon is called wave shoaling. Eventually the wave steepness increases and waves break to form the breaker zone. Thus, there is a need in the art to build coastal wave absorbing structures before this breaking zone.

### Wave Energy Extraction Mechanisms

The wave height or the wave slope can be used to absorb ocean wave energy. What is needed is a wave that induces relative motion between an object and a reference frame. This mechanical relative motion can then be converted using other techniques to eventually produce electrical power.

In deep water, the wave activity is mainly on the top. Thus, a reference point deep below where the wave action is low or nonexistent can be used. Hence, deep-water systems are typically moored to the bottom. However, in shallow waters a structure that spans from the top of the water surface down to the bottom of the seabed can be used that acts as a reference point. A moving body referenced to an earth fixed seabed has higher relative motion than two floating bodies connected to each other and are both are excited by waves, unless one can tune the two bodies to be out of phase which is difficult when wave frequencies change.

Ocean Power Technologies (Monroe, New Jersey) and Wavebob Ltd. (Dublin, Ireland) have constructed wave energy converters that use a floating body on the surface and a reference body deep down under the water to generate relative motion. These devices use vertical heave motion to convert relative mechanical motion to another form of energy. Ocean Power Technologies uses a linear electrical machine to convert the relative mechanical motion into electrical power. Devices like those constructed by Pelamis Wave Power (Orkney, Scotland) use the phase difference along the wavelength to generate relative motion. The Pelamis wave energy converter works on pitch motion which is the slope of the wave. Here, the relative motion at the joints is converted into hydraulic power that then drives the turbine to produce electrical power. There are oscillating surge converters that use the to and from motion in the direction of the wave to generate relative motion. One such device is the oscillating wave surge converter (OWSC). Generalizing, these techniques use any of the six degrees of freedom of motion of a body that is excited by waves with respect to some reference body to generate mechanical motion that is then converted to electric power.

Another class of devices allows the wave to run up a ramp into a reservoir and then use a low head hydro turbine to convert the stored potential energy in the water to generate power. There is one coastal device, called the tapered channel wave power plant (TAPCHAN), that has used this principle. These classes of devices are called overtopping devices. However, the cost of the device depends on the location at which a large reservoir can be constructed and is an expensive proposition and is only suited to certain site locations. There have been floating versions of this concept such as the wave dragon by Wave Dragon Aps (Copenhagen, Denmark).

### Oscillating Water Column (OWC)

One of the most researched and tested wave energy devices is the oscillating water column (OWC). The oscillating water column is a cavity resonator. FIG. 1 shows the working principal of an oscillating water column 100. Waves enter the hollow chamber through an opening 102 in the front. The water inside the chamber then oscillates thereby driving the air above through a turbine with a rotor 104 and a generator 106. The relative motion between the oscillating water column structure and the oscillating water column 100 is what is used to produce power. While a wave trough 108A is adjacent the oscillating water column 100, water moves toward sea and through the undertow, causing a falling water column 110A within the chamber. While a wave crest 108A approaches the oscillating water column 100, water moves toward shore, causing a rising water column 110B within the chamber.

Th main advantage of an oscillating water column is that it does not have any moving parts underwater. Maintenance costs are a major factor in estimating the Levelized Cost of Electricity (LCOE) in a marine, corrosive, unforgiving ocean environment. Moving parts underwater are a nightmare to repair when the weather is rough. After a rough event, not much is left to repair. One of the main reasons for the unfavorable economics of wave energy is that wave energy designs cater to the normal wave for wave absorption, whereas extreme hurricane-like conditions that occur though rarely, destroy these devices. Making the design survive extreme rare events makes the design expensive.

The next advantage which is a little bit more subtle is that the slow-moving ocean waves are accelerated through a pneumatic nozzle to generate high velocities that is suitable for efficient turbine and electrical power generation. The nozzle acts as a no moving part gearing mechanism. Electricity production is generally efficient at large speeds, and most wave energy devices use some form of gearing to improve power production. Most other devices have mechanical gearing that is subject to wear and tear.

Normally devices that use relative motion have moving parts in or under water which is very difficult to maintain in an unforgiving ocean environment. Maintenance underwater is an expensive proposition. Mechanical gearing to convert slow moving relative motion to high speeds is more cumbersome in a corrosive ocean environment. This might be the reason why the oscillating water column is the most tested and worldwide accepted wave energy conversion technique. See e.g., Heath, 2012, “A review of oscillating water columns.” Phil. Trans. R. Soc. A. 370235-245; and Vicinanza et al., 2019, “Review of Innovative Harbor Breakwaters for Wave-Energy Conversion.”

Another subtle point is that waves have low frequency (order of 10 seconds or 0.1 Hz) and impedance matching these devices to the wave, makes wave energy structures large. Large structures like bridges have low natural frequency. One of the new areas of research is to use flexible devices which can also address extreme loads while providing low-frequency resonance without increasing costs.

Thus, there exists a need in the art to improve the design of the oscillating water column to get better impedance matching.

### SUMMARY

The present disclosure uses flexible additions to the oscillating water column design, to achieve said better impedance matching. To reduce the size and to better tune the oscillating water column to waves, a flexible oscillating water column is integrated into a costal structure, such as a breakwater, with advanced controls. The flexible oscillating water column is thus a device based on the oscillating water column technology that uses flexible material with advanced controls to convert energy content in ocean waves to electric power.

The use of controls provides efficient operations close to the theoretical maximum and has the flexibility to tune the device depending on changes in wave climate across seasons. Most oscillating water column designs are fixed in frequency tuning once built.

The flexible oscillating water column demonstrates a novel breakwater unit. The flexible oscillating water column is the first device that generates electric power from sea waves known to the Arab area.

As water waves rise inside a chamber, the air flows into a turbine to generate electricity. An innovative flexible material along with advanced control technology are introduced in the flexible oscillating water column to generate a significantly higher amount of power.

The following objects, features, advantages, aspects, and/or embodiments are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of the present disclosure to generate green energy. The world has entered the Anthropocene age. Global warming is now an accepted fact. The data shows that climate change is one of the great challenges of the 21st century. Polar caps are melting, and the resulting water level rise disproportionately affects coastal regions which are in danger of flooding. These severe impacts can be avoided if renewable energy is used to offset some of the consumption of fossil fuels and their potential emissions. If implemented properly, wave renewable energy integrated into coastal structures can contribute to social and economic development, and secure and sustain energy supply where most of the population lives. Unlike the impedance matching of wave energy device to waves, here supply at the location are impedance matched to the demand at the coasts. Renewable energy also leads to a reduction of negative impacts of energy provision on the environment and human health. The multifunctional aspects of this wave absorbing coastal structures have other benefits than nonpolluting energy. Wave energy does not always need to be converted into electricity. The power output of the turbine can be directly coupled to high pressure pumps used for RO desalinization. It is thermodynamically unwise to convert to electricity and then bring it down to other forms of energy, unless there is long distance transmission requirement. Water is the next oil on which wars might be fought as the population increases. As the population grows, the supply of fresh potable water is in shortage. Other options for this energy source at the coast are to use the energy for refrigeration which could help fishermen. Unlike electricity both desalination and thermal storage (refrigeration) do not need continuous steady output. Both have built in storage. See e.g., Koola et al., November 1995, “Thermal storage as a multipurpose option for breakwater wave.”

energy plants.” The second European Wave Power Conference. Lisbon, Portugal. Energy produced at the coast can also be used for battery charging boats that operate along the coast thereby further reducing the pollution and supporting the supply at the location of demand. Electric outboard motors are already popular. Coastal barriers such as Ike Dike that, when completed, would protect the Houston-Galveston region including Galveston Bay from hurricane storm surge. On potential solution would thus be to combine such large infrastructure projects such as Ike Dike to house initial wave energy prototypes thereby reducing the infrastructure costs of individual wave energy prototypes. Galveston is a hurricane prone region, and other considerations might outweigh the benefits.

It is still yet a further object, feature, and/or advantage of the present disclosure to accelerate and standardize the design, build, and test of a wave absorbing coastal structure. Specifically, the concept of a flexible membrane can be designed, built, and tested to demonstrate changing the frequency response characteristics of a fixed geometry oscillating water column to a flexible oscillating water column.

It is still yet a further object, feature, and/or advantage of the present disclosure to test and generate a reference design that could be shared with any party that wants to build a coastal wave absorbing structure.

It is still yet a further object, feature, and/or advantage of the present disclosure to consider ease of construction, ensuring supply chain of materials and working through the permitting process requires a different kind of workforce.

It is still yet a further object, feature, and/or advantage of the present disclosure to carry out thorough exhaustive experimental and numerical data modelling for a coastal wave absorbing breakwater that can be leveraged with little extra effort to redesign for any location along the United States coast and even abroad.

It is still yet a further object, feature, and/or advantage of the present disclosure to provide a hydrodynamic absorption design and conduct proper hydrodynamics absorption experiments on 1:20 and 1:10 scale models in a wave tank with good accuracy and reliability that can be used to benchmark numerical code. These regular wave experiments will use the latest techniques of energy balance and air compressibility modeling to obtain well scaled results. Extreme wave force design experiments will continue using energy balance and air compressibility modeling to obtain well scaled results. These extreme wave force design experiments will also model geometry above still water level to check for wave run up and resulting extreme loads.

It is still yet a further object, feature, and/or advantage of the present disclosure is to develop numerical models using standard computation fluid dynamics (CFD) tools and use experimental data above to verify and validate the numerical model.

It is still yet a further object, feature, and/or advantage of the present disclosure is to practically implement the structural and power take off concepts described herein.

It is still yet a further object, feature, and/or advantage of the present disclosure to better tune the oscillating water column to waves. For example, a flexible oscillating water column (FlexOWC) integrated breakwater with advanced controls provides efficient operations close to the theoretical maximum. Further, the flexible oscillating water column has the flexibility to tune the device depending on changes in wave climate across seasons. Most oscillating water column designs are fixed in frequency tuning once built.

It is still yet a further object, feature, and/or advantage of the present disclosure to apply and demonstrate advanced controls on both regular fixed geometry oscillating water columns and flexible oscillating water columns.

It is still yet a further object, feature, and/or advantage of the present disclosure to develop algorithmic tools to automate the above results for CSI-WEC hydrodynamic absorption design.

It is still yet a further object, feature, and/or advantage of the present disclosure to prove the technical and commercial viability of a flexible oscillating water column.

It is still yet a further object, feature, and/or advantage of the present disclosure to look at the different configurations for wave energy devices and then pick the particular configuration best suited for the oscillating water column device that is well suited for coastal structures, such as breakwaters.

It is still yet a further object, feature, and/or advantage of the present disclosure to understand global needs and choose the location and site parameters for maximum economic impact.

It is still yet a further object, feature, and/or advantage of the present disclosure to build a sheltered zone close to the coast from the adverse effect of the waves, such as a wall along the coast to create a harbor wall that could protect fishing boats and other vessels.

It is still yet a further object, feature, and/or advantage of the present disclosure to optimize (i) the shape of the flexible oscillating water column for maximum hydrodynamic performance, (ii) the absorption efficiency of the flexible oscillating water column, and (iii) the structural loading on the flexible oscillating water columns. One of the key criteria that can determines how much energy can be captured by the oscillating water column is the frequency response of the oscillating water column.

It is still yet a further object, feature, and/or advantage of the present disclosure to build a flexible oscillating water column from a hollow caisson that can be towed and seated on a preprepared flat bed at site. Then the cavity can be filled with dredged material around the site.

It is still yet a further object, feature, and/or advantage of the present disclosure to further reduce the maximum wave loading by reducing the freeboard above mean sea water level.

It is still yet a further object, feature, and/or advantage of the present disclosure to eliminate metallic structures exposed to corrosive seawater from the design of the flexible oscillating water column.

It is still yet a further object, feature, and/or advantage of the present disclosure to increase the bandwidth of the flexible oscillating water column by making the flexible water operating column multi-resonant. Adding a flexible element with a different frequency response to the oscillating water column allows for one resonance to be used for fixed geometry and another resonance peak for the flexible element. This flexible element could be placed either in series or parallel with the air flow.

It is still yet a further object, feature, and/or advantage of the present disclosure to acquire reference design data.

It is still yet a further object, feature, and/or advantage of the present disclosure to collaborate with marine coastal construction companies and energy operators to build working structures. Building the first structure can be expensive as specific instrumentation for quantification must be carried out. Since many such plants across the globe have already been tested, the process of building structures can be accelerated through the expertise of experienced team members.

It is still yet a further object, feature, and/or advantage of the present disclosure to employ a team of researchers across universities who have joined forces to start a small business to crack this unsolved puzzle of wave energy economics.

It is still yet a further object, feature, and/or advantage of the present disclosure to thoroughly research the flexible oscillating water column concept in wave flumes and tanks at other university partner facilities to better commercialize systems that can benefit the public.

The flexible oscillating water column disclosed herein can be used in a wide variety of applications. For example, coastal structures that incorporate the flexible oscillating water column can double as harbors for the storage, shipping, and transport of goods. In yet another example, the flexible oscillating water column can be used with a variety of breaking wave types, such as spilling breakers (which generally occur on gently sloped beaches, where the wave energy dissipates gradually as it breaks), plunging breakers (which generally form on steeper slopes, creating a more dramatic breaking action with a curling crest), and surging breakers (which generally happens on very flat beaches, where the wave surges forward with minimal breaking action).

It is preferred the flexible oscillating water column be safe to employ, cost effective and simple to build, and durable.

For example, the flexible oscillating water column can be adapted to resist excessive heat, static buildup, corrosion, and/or mechanical failures (e.g. cracking, crumbling, shearing, creeping) due to excessive impacts while at sea and/or prolonged exposure to tensile and/or compressive forces acting on the flexible oscillating water column.

In yet another example, eliminating the requirement for bidirectional power flow in the flexible oscillating water column significantly reduces the cost and complexity of the power take-off, while harvesting energy at a level comparable to that of a rigid oscillating water column that uses a bidirectional power flow power take-off. The flexible and advanced control technologies in the flexible oscillating water column can also help to reduce the cost of electricity. The maintenance cost of the flexible oscillating water column is relatively small, which further reduces the overall cost of electricity.

In yet another example, the design of the flexible oscillating water column is such that the center of mass is on the original breakwater structure. The material of the flexible oscillating water column can be any material suitable for ocean structures such as concrete or fiber-reinforced plastic.

Methods can be practiced which facilitate use, manufacture, assembly, maintenance, and repair of an oscillating water column which accomplish some or all of the previously stated objectives. For example, a coastal structure integrated wave energy convertor (CSI-WEC) can be used to lower needed maintenance (as there are no moving parts under water) and lower levelized cost of energy (LCOE).

The oscillating water column can also be incorporated into systems which accomplish some or all of the previously stated objectives. A diverse portfolio of renewable energy sources would include solar, waves, and wind. Including the flexible oscillating water column to generate electricity from sea waves increases the diversity of clean energy resources, especially in the Arabic peninsula. In some examples, the flexible oscillating water column can also be directly incorporated into a renewable energy system that generates electricity using wind power (e.g., one that is driven by a wind turbine) or solar power (e.g., one that is driven by the use of solar panels).

Many renewable energy sources and structures that generate renewable energy must be transported via cargo ships or planes from distant areas of the world, thereby undercutting their contributions toward limiting negative effects of climate change. In one non-limiting example, the Flexible oscillating water column can be constructed in manufacturing facilities in the Arabic peninsula, used to generate power in the Arabic peninsula, and will then add to that same economic growth in the region in which they were constructed, as opposed to distant regions that have been economically dominant for much of the World's recent history.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1A and FIG. 1B illustrate an oscillating water column wave energy device.

FIG. 2 shows a multi-functional wave energy integrated breakwater concept.

FIG. 3 shows water jetting-active wave dissipation tests in flume.

FIG. 4 shows global offshore annual wave power level distribution (Cornett July 2008).

FIG. 5 shows a typical breakwater.

FIG. 6 shows the Queen's University Belfast 75 KW demonstrator on Islay (Heath 2012).

FIG. 7 shows the Voith Hydro Wavegen LIMPET oscillating water column (Heath 2012).

FIG. 8 shows the Mutriku breakwater including 16 oscillating water column chambers.

FIG. 9 shows oscillating water column breakwater at Sakata Port in Japan (Horvath 2009).

FIG. 10 shows a photomontage of the Siadar breakwater (Heath 2012).

FIG. 11A shows a general view of the Mutriku structure after the storm.

FIG. 11B shows a detailed view of the most damaged chamber of the Mutriku structure.

FIG. 12 shows a 50 kW oscillating water caisson breakwater prototype that pumped power to Indian national power grid in the early 1990s.

FIG. 13 shows a cut section view of an oscillating water caisson.

FIG. 14 shows a breakwater overtopping.

FIG. 15 shows one proposed design of an oscillating water column array, according to some aspects of the present disclosure.

FIG. 16 illustrates a top perspective view of a flexible oscillating water column, according to some aspects of the present disclosure.

FIG. 17 illustrates a bottom perspective and detailed view of the flexible element of the flexible oscillating water column of FIG. 16, according to some aspects of the present disclosure. The cast is shown upside down.

FIG. 18 illustrates a rear perspective and detailed view of the flexible element of the flexible oscillating water column of FIG. 16, according to some aspects of the present disclosure. The flexible element can be flipped and lowered using a crane.

FIG. 19 graphs that bang-singular-bang and complex conjugate controls harvest the same high energy level and need bidirectional power flow. Resistive-loading control harvests much less energy and needs no bidirectional power flow, according to some aspects of the present disclosure.

FIG. 20 graphs the harvested energy for irregular wave spectrum, according to some aspects of the present disclosure.

FIG. 21 graphs power take-off power for an irregular wave, according to some aspects of the present disclosure.

FIG. 22A, FIG. 22B, FIG. 22C, FIG. 22D, and FIG. 22E illustrate a numerical wave tank used to test scale flexible wave energy converters, according to some aspects of the present disclosure.

FIG. 23 shows numerical results of high-fidelity simulations for the kinetic energy of flexible and rigid scale spheres, computed using a damping control force on each, according to some aspects of the present disclosure.

FIG. 24A, FIG. 24B, FIG. 24C, and FIG. 24D show a scaled oscillating water column model, according to some aspects of the present disclosure.

FIG. 25 shows a towing tank test setup (University of Iowa), according to some aspects of the present disclosure.

FIG. 26 graphs turbine performance curves, according to some aspects of the present disclosure.

FIG. 27 compares wave piston heave, air chamber gauge pressure, and turbine velocity plots, according to some aspects of the present disclosure.

FIG. 28 compares floating oscillating water column system heave, pressure, and turbine velocity states, according to some aspects of the present disclosure.

FIG. 29 shows accumulated generator energy, according to some aspects of the present disclosure.

FIG. 30 graphs membrane response, according to some aspects of the present disclosure.

FIG. 31 compares wave piston heave, air chamber gauge pressure, and turbine velocity plots, according to some aspects of the present disclosure.

FIG. 32 compares floating oscillating water column system heave, pressure, and turbine velocity states, according to some aspects of the present disclosure.

FIG. 33A compares pneumatic power curves for use with no membrane and use with a membrane, according to some aspects of the present disclosure.

FIG. 33B graphs electric generator performance curves related to efficiency for use with no membrane and use with a membrane, according to some aspects of the present disclosure.

FIG. 34 graphs membrane response, according to some aspects of the present disclosure.

FIG. 35 shows a cross section view of a wave flume, according to some aspects of the present disclosure.

FIG. 36 shows an oscillating water column test section mesh, according to some aspects of the present disclosure.

FIG. 37 shows a wave generator section mesh, according to some aspects of the present disclosure.

FIG. 38 shows a deformed and underformed membrane element, according to some aspects of the present disclosure.

FIG. 39 shows a membrane orientation at time t=40 sec, according to some aspects of the present disclosure. The membrane is located on the right and the left sides of the orifice.

FIG. 40 shows an average membrane displacement over time, according to some aspects of the present disclosure.

FIG. 41 shows average flow velocity in the turbine, according to some aspects of the present disclosure.

FIG. 42 shows a hydrodynamic model of an oscillating water column breakwater wall, according to some aspects of the present disclosure.

FIG. 43 shows three-dimensional oscillating water column dimensions, according to some aspects of the present disclosure.

FIG. 44 shows a three-dimensional oscillating water column showing normals pointing into fluid, according to some aspects of the present disclosure.

FIG. 45 shows the frequency response (LH5 constant) for lip immersion depth (LD), according to some aspects of the present disclosure.

FIG. 46 shows the frequency response (LD3 constant) for harbor length (HL), according to some aspects of the present disclosure.

FIG. 47 shows the frequency response for harbor length (HL)-lip depth (LD), according to some aspects of the present disclosure.

FIG. 48 captures a hydrodynamic model of an oscillating water column breakwater wall in flume, according to some aspects of the present disclosure.

FIG. 49 renders a modular construction for a three-dimensional oscillating water column, according to some aspects of the present disclosure.

FIG. 50A shows a top plan view of an oscillating water column model, emphasizing dimensions of same, according to some aspects of the present disclosure.

FIG. 50B shows a front elevation view of the oscillating water column model of FIG. 50A, emphasizing dimensions of same, according to some aspects of the present disclosure.

FIG. 50C shows a side elevation view of the oscillating water column model of FIG. 50A, emphasizing dimensions of same, according to some aspects of the present disclosure.

FIG. 51A shows a top plan view of an example wave flume, emphasizing dimensions of same, according to some aspects of the present disclosure.

FIG. 51B shows a front elevation view of the example wave flume of FIG. 51A, emphasizing dimensions of same, according to some aspects of the present disclosure.

FIG. 52 captures orifice dampers, according to some aspects of the present disclosure.

FIG. 53 captures an air compressibility drum, according to some aspects of the present disclosure.

FIG. 54 shows an elastic membrane for a flexible oscillating water column, according to some aspects of the present disclosure.

FIG. 55 displays a DATAVIEWER tool, according to some aspects of the present disclosure.

FIG. 56 displays a DATAVIEWER menu, according to some aspects of the present disclosure.

FIG. 57 shows wave measurements in front of an oscillating water column, according to some aspects of the present disclosure.

FIG. 58 shows measurements inside the oscillating water column, according to some aspects of the present disclosure.

FIG. 59 shows an overplot of four damping cases, according to some aspects of the present disclosure.

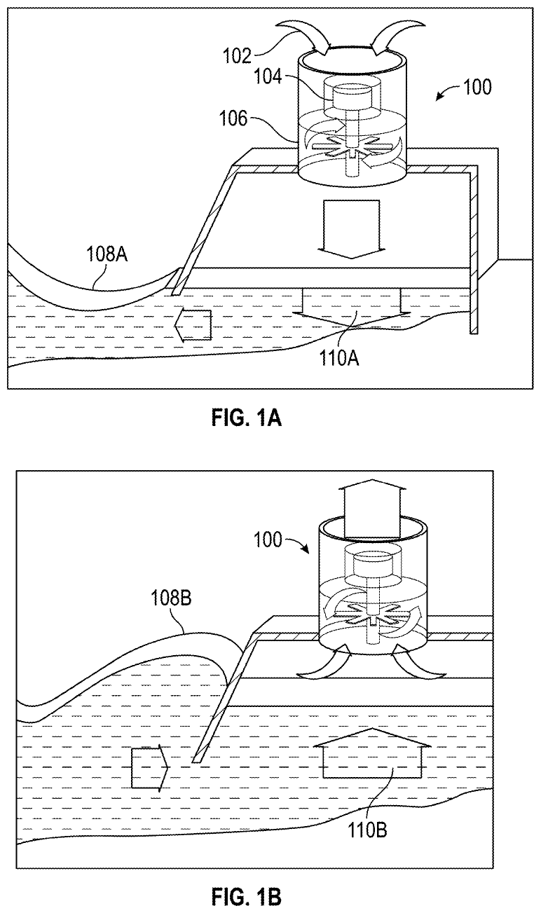

Figure A of the appendix graphs heave response vs. wavelength, according to some aspects of the present disclosure.

Figure B of the appendix charts Morocco wave data, according to some aspects of the present disclosure.

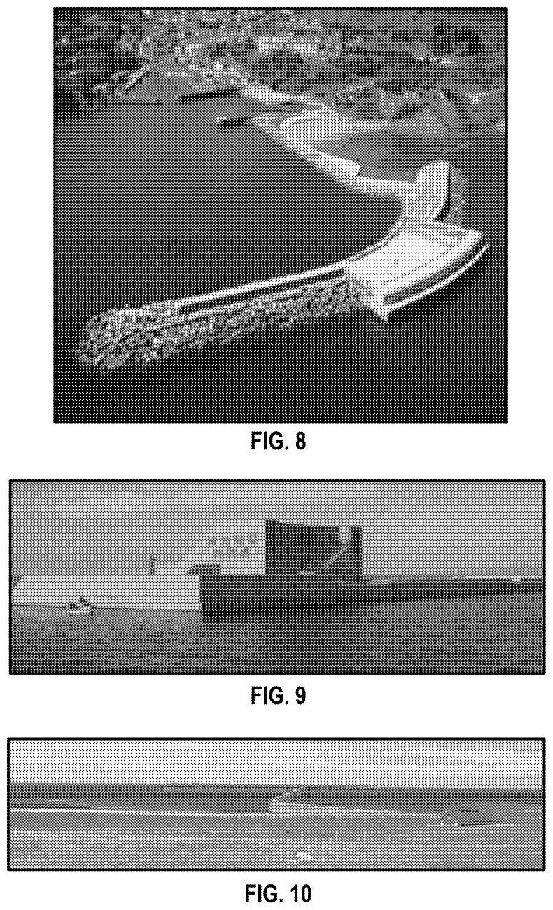

Figure C of the appendix plots significant wave height (m) as a function of peak period(s) for the Morocco wave data of FIG. 8, according to some aspects of the present disclosure.

Figure D of the appendix graphs a typical spectrum of energy density (m² Hz) as a function of peak period(s), according to some aspects of the present disclosure.

An artisan of ordinary skill in the art need not view, within isolated figure(s), the near infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

### Wave Energy Configurations

Several different configurations are possible for wave energy devices. The particular configuration best suited for modifying an oscillating water column was considered from the group consisting of the four main classes of wave energy devices: (i) a point absorber (e.g., U.S. Pat. No. 4,858,434); (ii) an attenuator (e.g., Washio et al., 2000, “The offshore floating type wave power device ‘mighty whale’: open sea tests,” In: Proceedings of the tenth international offshore and polar engineering conference. Seattle: ISOPE.); (iii) a terminator (e.g., Raju et al., July 1993, “Experiences on a 150 kw Wave Energy Pilot Plant.” Edinburgh, U.K.: Proceedings of the 1993 European Wave Energy Symposium; Heath, 2012, “A review of oscillating water columns.” Phil. Trans. R. Soc. A. 370235-245); and (iv) a very large floating structure (e.g., Koola et al., 2003, “The dynamics of Wave Carpet—A novel deep-water wave energy design.” San Diego, California: OCEANS, MTS/IEEE Conference Proceedings-. 2288-2293.).

The point absorber is classified as a device that is small compared to the wavelength. Ocean Power Technologies (Monroe, New Jersey) and Wavebob Ltd. (Dublin, Ireland) have constructed wave energy converters that are point absorber devices. The order of magnitude a deepwater wavelength in a point absorber for a ten second (10 s) wave period is about one hundred fifty-six meters (156 m). A small, compared to wavelength, axisymmetric floating cylinder is omni directional and is a possible choice when waves come in from all directions. However, the theoretical maximum power absorption for an axisymmetric device in heave motion is fifty percent (50%).

When the device's geometry gets comparable to wavelength then waves will diffract around the device. When the sea surface is looked at from above, a large device is had whose cross section at water plane is close to an ellipse like a ship. The semi-major axis of the ellipse is much greater than the semi minor axis. If the ship bow points into the wave perpendicular to the wave crest, an attenuator is created and the wave glides by its side slowly being absorbed along the length of the device. The wave energy converter by Pelamis Wave Power (Orkney, Scotland) is such a wave energy device.

On the other hand, if the ship like device is broad side facing the waves, then the oscillating water column is in a terminator configuration. Most coastal wave energy devices take on this terminator configuration, terminating the waves on the structure.

The remaining class, very large floating structures (VLFS), is much larger than the wavelength, in both length and width. Generally, structures this big will flex in waves and will exhibit hydroelasticity behavior. A wave carpet (Koola 2003) is such a device mentioned here, only for the completion of possible configurations seen to date.

### Coastal Structures

There are different kinds of coastal structures such as breakwaters, seawalls, jetties, piers, groins and harbors. Some coastal structures are built parallel to the coastline and others perpendicular to the coastline for different purposes. The present disclosure discloses a wall built along the coast to create a harbor wall that could protect fishing boats and other vessels. These harbor walls create a sheltered zone close to the coast from the adverse effect of the waves. These harbors could also be used in shipping and transport of goods such as port facilities. These shipping berths on the shore side of the breakwater provide protection from waves. These berths could also be used for storage of goods.

Currently these harbors are built using rubble, concrete tetrapod's or other concrete engineered interlocking material or concrete blocks or even caissons. These devices are called dissipative breakwaters as the wave energy is dissipated on the device.

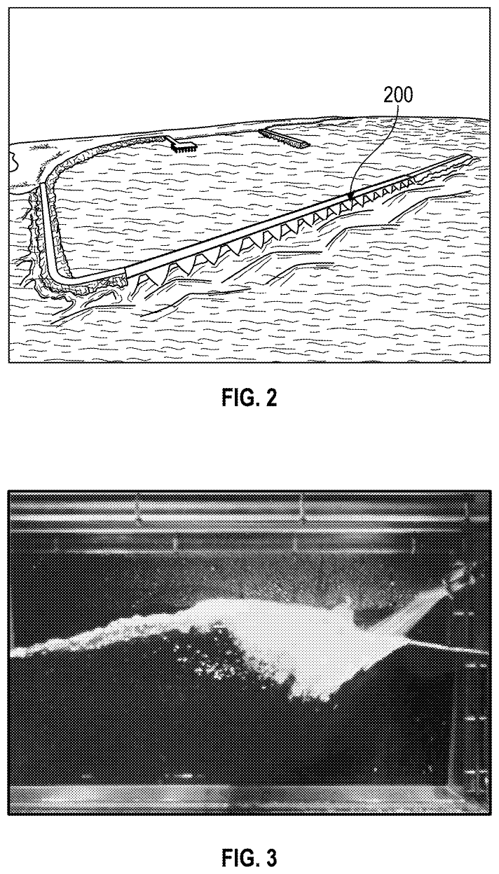

Our intent is to create a wave absorbing device that not only reduces forces on the structure but generates energy as a byproduct. Such a multifunctional breakwater concept is shown in FIG. 2 and is one way to reduce wave energy production costs by sharing the structure with other requirements. In FIG. 2 along the shallow depth regions and regions whose orientation is not appropriate for wave absorption is built using conventional rubber mound or other breakwater construction techniques. The deeper zone where there is good wave activity and whose orientation is worthy of wave energy absorption is built using wave absorbing caissons.

Coastal structures can be classified as: (1) passive dissipative, where waves break on the structure (rubble mound, etc.); (2) wave absorbing integrated structures, and (3) active dissipative wave integrated structures, which use wave energy to reduce forces.

Active dissipative structures that use stored wave energy to counteract extreme wave forces thereby reducing structural forces are shown in FIG. 3. See e.g., Koola et al., April 1999, “Multifunctional wave absorbing breakwaters with extreme force dissipation.” 5th Int. Conference on Coastal and Port Engineering in Developing Countries. Cape, Town, South Africa: COPEDEC.

### Coastal Wave Energy Absorbing Structures

Coastal regions where waves have not broken and dissipated, typically have a water depth of about ten meters (10 m). As waves propagate to the coast the maximum estimated wave height is about 0.78 times the water depth before they break. So, at a ten-meter (10 m) water depth a maximum wave height of about 7.8 meters is expected. In deep water, wave steepness is the governing breaking criteria. However in shallow waters, the governing breaking criteria is water depth. One of the reasons wave energy is expensive is because structures must be designed to survive extreme but rare events but absorb only from relatively calm regular wave climates. Hence, most of the time there is an expensive structure sitting idle and encountering only smaller waves than what the oscillating water column is designed for. The self-regulating wave breaking in shallow water helps reduce the cost of energy on top of the multifunctional cost sharing.

Another option is to pick a location where the difference between extreme maximum wave and average wave is small. As an example, in the Northern Hemisphere, eastern coasts (e.g., Florida) are subject to hurricanes and western coasts (e.g., Oregon) have less probability of hurricanes. This is why for the Indian Wave Energy Plant, the west coast of India at Vizhinjam was chosen as the site location (Raju, 1993).

Waves coming in from the deep ocean towards the coast refract due to bottom topography and in general come normal to the coastline. There will be directional changes, but in general the variations along the coast are much smaller than in deep ocean. Smaller directional changes reduce the design constraints. Given a representative water depth and limited wave direction, the design should focus on changes in wave period and wave height. The statistics of these parameter variations can be optimized for energy conversion. One of the goals of the present disclosure is to create a representative design for an oscillating water column wave absorbing structure. Global needs and site parameters can factor into the location for maximum economic impact.

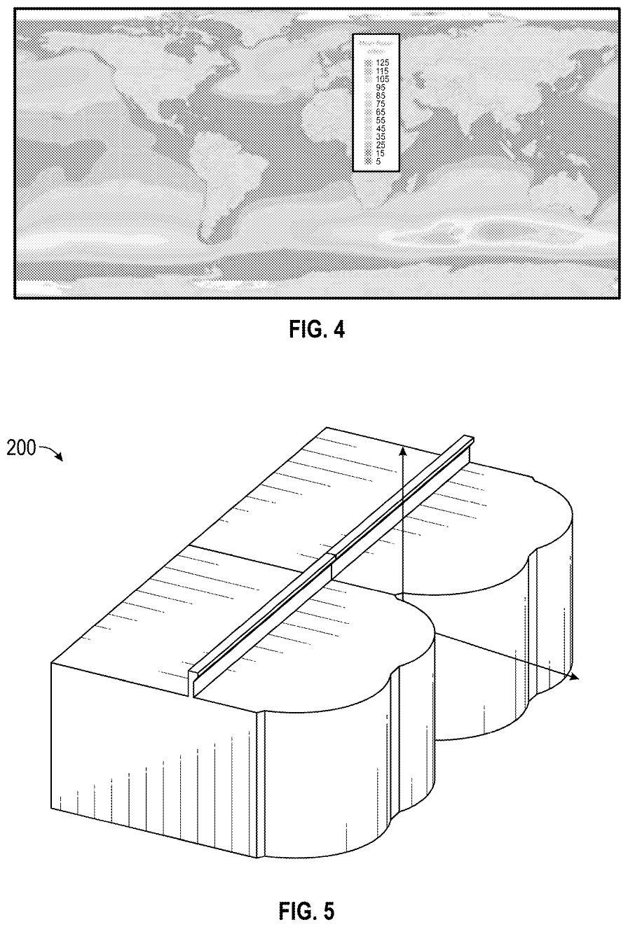

In general, the wave activity at the coastal zone is much smaller than in deeper waters. As shown in FIG. 4, the power along 30° N and 30° S of the equator has the maximum wave power with wave activity along the equator generally smaller. But there seems to be an annual average wave power potential of about ten kilowatts (10 kW) per meter along most coasts of the world. Hence, 10 kW/m can be used as a representative annual average wave power to further analyze the design.

### Reference Design

The oscillating water column 200 that is illustrated in FIG. 5 evolved from a simple axisymmetric lighting buoy (see e.g., U.S. Pat. No. 4,858,434) to become a terminator type breakwater wall (Raju et al., July 1993, “Experiences on a 150 kw Wave Energy Pilot Plant.” Edinburgh, U.K.: Proceedings of the 1993 European Wave Energy Symposium).

The axisymmetric buoys can only absorb 50% maximum whereas a terminating oscillating water column 200 can absorb 100% theoretical maximum if referenced to earth fixed coordinates, a bottom standing device. This wall can also act as a harbor, thereby sharing the cost across multiple functions reducing cost of power production. This restricts the design to locations which require a protective harbor wall.

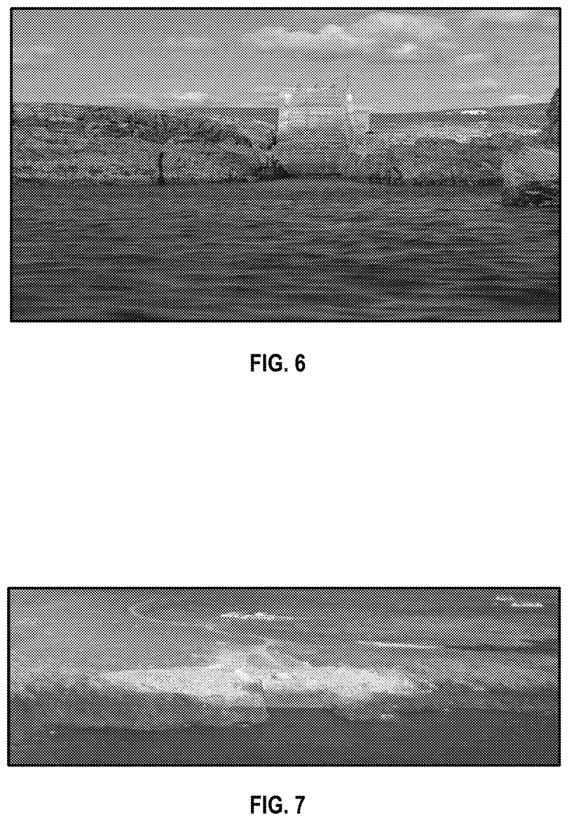

FIG. 6 and FIG. 7 show oscillating wave power plants on rock cliffs on the shore with sufficient water depth at the cliff face. FIG. 8, FIG. 9, and FIG. 10 depict plants self-standing on the sea floor. See e.g., Heath, 2012, and Vicinanza et al., 2019. The present disclosure focuses on the latter design where there are many more locations suitable for such a design.

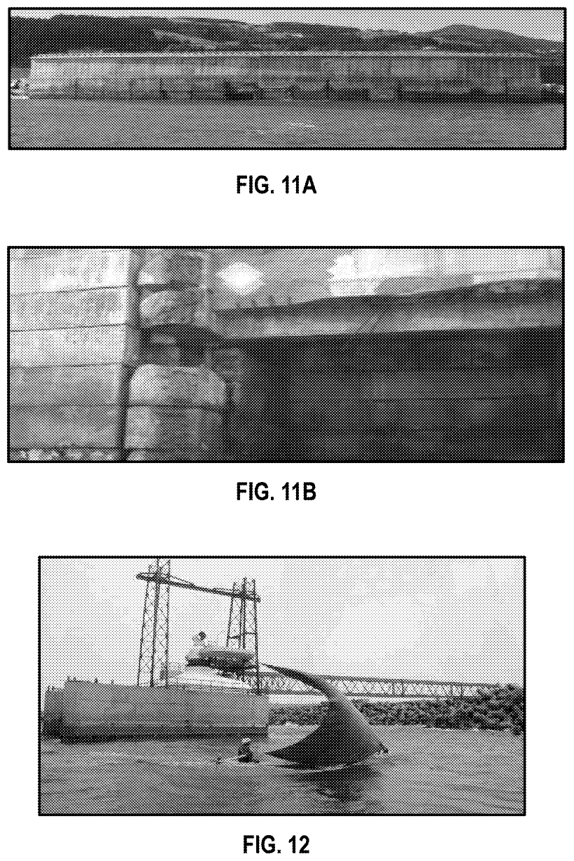

Voith Hydro Wavegen (Inverness, Scotland) is the company partnering with utilities in two of these oscillating water column coastal structure projects. The first of these is at Mutriku (FIG. 8) in the País Vasco of northern Spain, where the energy authority Ente Vasco Energia (EVE). The second project is at Siadar (FIG. 10) on the northwest coast of Lewis in Scotland. See e.g., Heath, 2012. Unfortunately, the Mutriku structure was damaged in a storm (FIGS. 11A and 11B) and highlights the necessity to better study these structures before deploying them at sea.

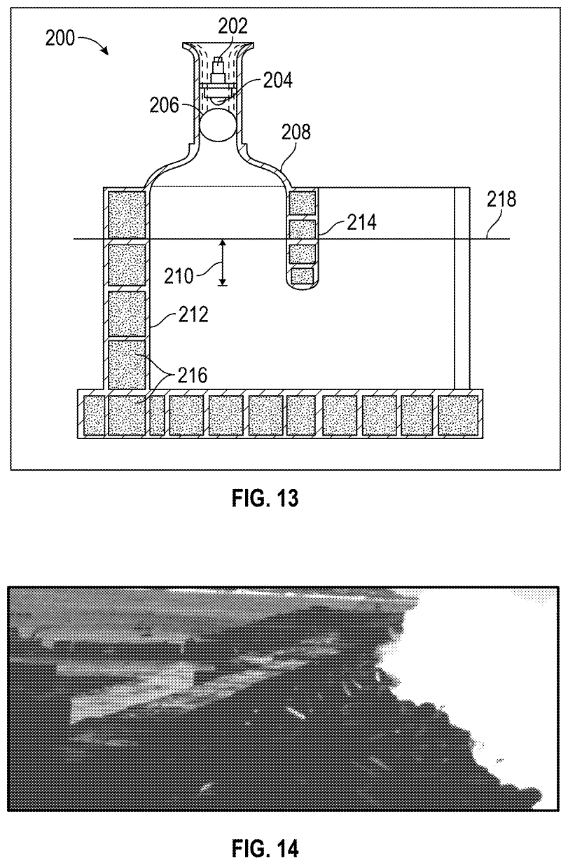

FIG. 12 shows the research oscillating water column prototype designed, built and operated by one of the present inventors who did his doctoral dissertation on this device design. FIG. 13 shows the cut section to see inside the device, which includes a generator 202, turbine 204, butterfly valve 206, dome 208, oscillating water column 210, back wall 212, lip wall 214, sand fillings 216, and a still water level 218. This device was a free standing, shallow water breakwater module 200 built with the sole purpose of understanding the hydrodynamics of the device. For ease of access, this concrete caisson was towed and seated in front of an existing breakwater. This facility was later declared as a national test facility for full scale pulsating air turbine research. The intent of these figures is to highlight the design a wave absorbing breakwater should not have such a configuration above water. This above mean water level design was for mainly research and ease of access. The test facility has been decommissioned after almost two decades of functioning from 1991 until 2011.

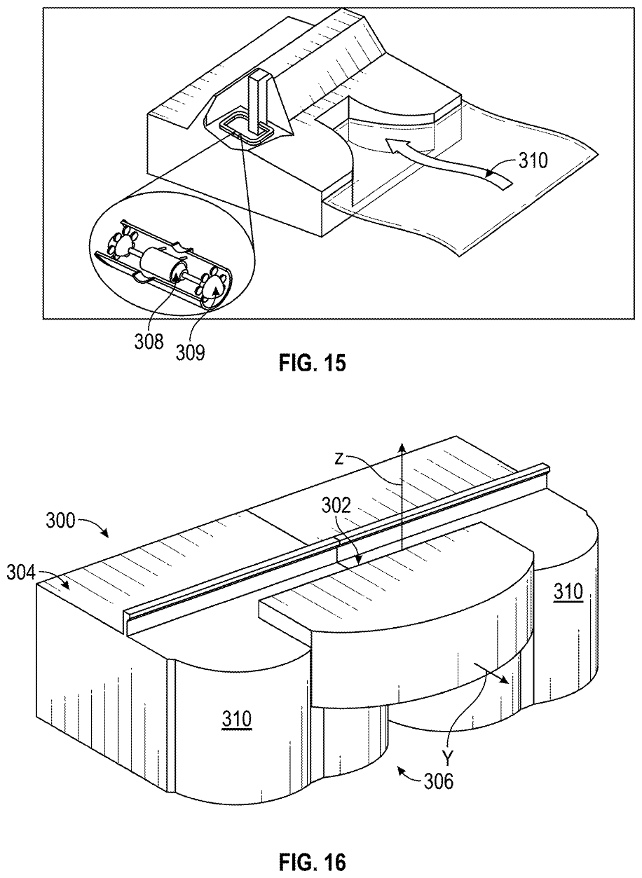

In the most extreme wave conditions, harbor walls are not in operation, and there is an opportunity to further reduce the maximum wave loading by reducing the freeboard above mean sea water level. If the reference coastal water depth is chosen as ten meters (10 m), the maximum wave height will be about 7.8 meters. This height will also depend on the functionality of the harbor wall. Shallow water waves are asymmetrical about the mean water level and the wave crests above mean level are higher than the troughs below sea level. If the harbor wall height above mean sea level is less than the wave crest elevation the wall clips the top of the wave resulting in overtopping over the top of the device. Wave overtopping in extreme weather is common in breakwater designs, as shown in FIG. 14. All operations on the breakwater are curtailed during these extreme events.

FIG. 15 shows a commercial design of one unit of an oscillating water column array when stacked side by side and will form the multifunctional breakwater as shown in FIG. 2. The special feature of this design is that there are no metallic structures exposed to corrosive seawater. The rigid surface 304, or the entire caisson outside surface, is marine concrete. The next notable fact is that the oscillating water chamber does not span the entire width of the caisson. The side chambers inside the caisson are where the turbines are housed. This is also driven by the fact that wave potential close to coast is smaller and hence it is possible to capture most of the incoming energy even with partial wave capture zones. Most other designs use adjacent oscillating water column chambers. In fact, it is known that protruding harbor walls in front of an oscillating water column increase the bandwidth and decrease the cavity size.

The ducting from the top of the oscillating water column is vertically brought down and then horizontally turned to prevent water particle ingress into the air turbines. This is a water particle flow trap. Heavier water particles fall to the bottom of the vertical shaft. The collected water can then be returned to the sea.

The turbine 308 as shown in FIG. 15 is a twin thrust cancelling wells turbine configuration reducing bearing loads for better maintenance. The focus of the present disclosure is on the concrete caisson and the delivery of pulsating air which accounts for the capital-intensive budget of this technology. The turbine research is not the primary focus of the present disclosure but can be considered to satisfy any constraints that are imposed on the oscillating water column structure. The height of this device above mean water level will determine the wave crest cut off. This will also determine how much wave force is transferred to the device. A focus on the wave force loading on the structure can be critical for estimation of levelized cost of energy (LCOE).

One of the key criteria that determines how much energy can be captured by the oscillating water column is the frequency response of the oscillating water column. This includes the transfer function from the wave to the device and the frequency range or bandwidth of operation. Since the frequency response and bandwidth have a first order effect on the effectiveness of the device, the present disclosure focuses on this for commonly occurring waves. After this basic requirement is demonstrated, wave forces are then measured for extreme overtopping waves. The present disclosure also addresses how to overcome wave forces when power absorption is not functioning. For example, this is a good case to test active dissipation techniques for force reduction which for the structure of FIG. 12. See e.g., Koola et al., 1999.

While obtaining solid design data from both experiments and numerical modelling the research would not be complete without pushing the boundaries of the state of the art. Hence, one aim of the present disclosure is to generate generic design tools for wave absorbing coastal structures. Two specific sub-plans to achieve this aim include: a) flexible elements and 2) advanced controls.

Innovative Research (FlexOWC with Advanced Controls)

As mentioned, large structures have low natural frequency. Large ocean waves have low frequency. Designing wave energy devices can include building devices that resonate to these low frequencies. Another issue is that waves have different frequencies corresponding to different wavelengths. All physical systems are band limited. This means that there is a range of frequencies that are associated with a physical phenomenon like water wave generated by winds. The oscillating water column is a cavity resonator with its own frequency response. To impedance match a fixed dimension oscillating water column's frequency response to the wave spectrum different geometry configurations were researched. Irrespective of the best geometry for a given wave frequency that one can choose, once chosen the geometry is fixed for a concrete caisson oscillating water column. Any means of altering the behavior of the device is normally only using controls on the flow. Indirectly this means turbo generator loading control.

The power output of an oscillating water column is the product of the pressure drop across the turbine 308 and the flow rate through it. The goal is to get the pressure and flowrate in phase which it is usually not. This technique is called phase control. By altering the speed of the turbine 308 one can in principle control the pressure flow rate characteristics, thereby power output. However, the range of variations possible due to load control is limited compared to the seasonal changes in wave climate for any given site. A fixed geometry design is not ideal for a large fluctuating wave input. Changing the device characteristics through shape changes across season is expensive as it violates the fundamental advantage of the oscillating water column, namely no moving parts in water. Hence flexible devices that could be added to the existing system chain might be a good possible option.

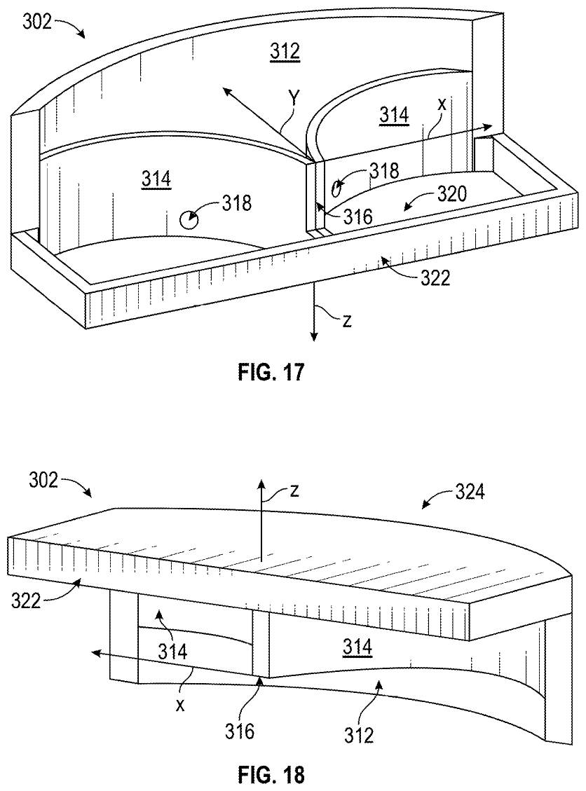

As shown in FIGS. 16-18, adding a flexible element 302 with a different frequency response to the oscillating water column 304 increases the bandwidth by making it multi-resonant, one for fixed geometry and another resonance peak for the flexible element 302. This like adding harbor walls to the oscillating water column 304. One concept involves placing a rubber membrane in the air flow chamber 306 away from the oscillating water 310. This added element could alter the frequency response of the device. Why this is interesting is because the air is shielded from extreme wave activity. This flexible membrane 302 can be placed inside the protected region of the air chamber 306 shown in FIG. 15. This then allows easier maintenance without needing to get into the water. When the weather is rough, the system can be shut down with one or more valves 309. This strategy can be used to replace the cheaper flexible element (as compared to total capital costs of the whole system chain) more frequently. Different membranes can thus be utilized for different seasons.

This flexible element 302 could be placed either in series or parallel with the air flow. If placed in series, the flexible element 302 must displace air flow equivalent to the flow volume per cycle. If placed in parallel it acts as elastic storage like an air vessel in preventing water hammer and shock loads. This elastic storage will come in handy for optimal controls where a larger reactive component is required to achieve close to theoretical maximum energy absorption.

The flexible oscillating water column 300 includes a front wall 312, curved subwalls 314 the terminate at a central wall 316, reliefs 318 in the curved subwalls 314, a top surface having a bottom side 320 and top side 324, and a rear edge 322.

Experimental scale modelling this elastic component while simultaneously satisfying Froude scaling can be critical to successful wave hydrodynamics testing. One can alleviate this bottleneck using full scale numerical modeling after verifying and validating numerical model at small scales.

### Advanced Controls

The significance of the flexible oscillating water column is best understood when considering the device from the control perspective. Consider a typical rigid oscillating water column which is usually connected to a generator that is fixed on a stationary reference platform. In order for the oscillating water column to convert wave power to electric power, the oscillating water column has to resist the wave. Resisting the wave is achieved via the pressure above the water surface in the oscillating water column. The amount of power harvested from ocean waves is dictated by this resistance (air pressure in the oscillating water column). This pressure is impacted by the motion of the turbine blades (the velocity of the blades dictates the air exit velocity and hence the air pressure). On the other hand, the generator converts the kinetic power in the blades into electric power, and also the generator pushes back with a torque that is proportional to the generated electric current. This torque is usually referred to as a “control force”. This control force (torque) acts on the shaft, impacting the blades motion, and hence the air pressure in the oscillating water column. The power take-off (PTO) unit in the oscillating water column includes the generator and its control, and it outputs the electric power and the control force on the shaft.

Considering the kinetic power for a rigid oscillating water column, and studying the optimal control problem to find the “control force” that would result in the maximum kinetic power from a given wave spectrum, it was found that the optimal control force requires a spring-like force, in addition to the resisting force. See e.g., Fusco et al., 2011, “Suboptimal causal reactive control of wave energy converters using a second order system model.” In Proc. of the 21st Intl. Offshore and Polar Engineering Conf., pages 687-694. This spring-like control force means that the power take-off needs to put power into the ocean at times in order to harvest power at a significantly higher rate at other times. The power flow from the power take-off to the ocean will be referred to as “reactive power” in the present disclosure. The reactive power has the opposite direction of power flow compared to the power harvested from the ocean into the power take-off. Hence, the power take-off unit in the oscillating water column needs to have a bidirectional power flow capability; a power take-off that has this bidirectional power flow capability is more complex to build. This challenge can be overcome using the flexible material 302 in the flexible oscillating water column 300.

Eliminating the requirement for bidirectional power flow in the flexible oscillating water column significantly reduces the cost and complexity of the power take-off, while harvesting energy at a level comparable to that of a rigid oscillating water column that uses a bidirectional power flow the power take-off. This concept can be conceived as obtaining the spring-like force from the waves themselves, instead of obtaining it from the power take-off. The elastic material acts as energy storage. This elastic storage will come in handy for optimal controls where a larger reactive component is required to achieve close to theoretical maximum energy absorption. This is inspired by how marine animals employ rapid shape change for propulsion and maneuvering.

The present disclosure answers a few questions and problems present in the art, see e.g., Abdelkhalik, 2020. “Control Of Novel Variable-Shape Converters For Natural Harvesting of Ocean Wave Energy.” NSF Award #2023436, via the with the flexible oscillating water column concept. First, the optimal shape should be changed to maximize harvested power. Second, an explicit solution for the optimal control force is derived in the context of optimal control theory. Third, a method to write the governing equations of motion is the dynamic model of the flexible oscillating water column.

### Optimal Control for the Flexible Oscillating Water Column

This section highlights the innovation in the control of the flexible oscillating water column and presents results. To maximize the harvested energy, the optimal solution for a rigid flexible oscillating water column, derived in the frequency domain, is the complex conjugate (CC) of the mechanical impedance, which is noncausal. Thus, implementations of this optimal solution for rigid oscillating water columns are usually approximate solutions. In any case, this complex conjugate control requires bidirectional power flow. To further examine this case, consider the time domain optimal control problem of a rigid wave energy converter (WEC), where the optimization objective is to maximize the harvested energy. A closed form explicit solution has been developed for the optimal control force, and this solution is known as Bang-Singluar-Bang (BSB) control. See e.g., Zou, April 2017, “Optimal Control of Wave Energy Converters”, Elsevier, Renewable Energy, Vol 103, pages 217-225.

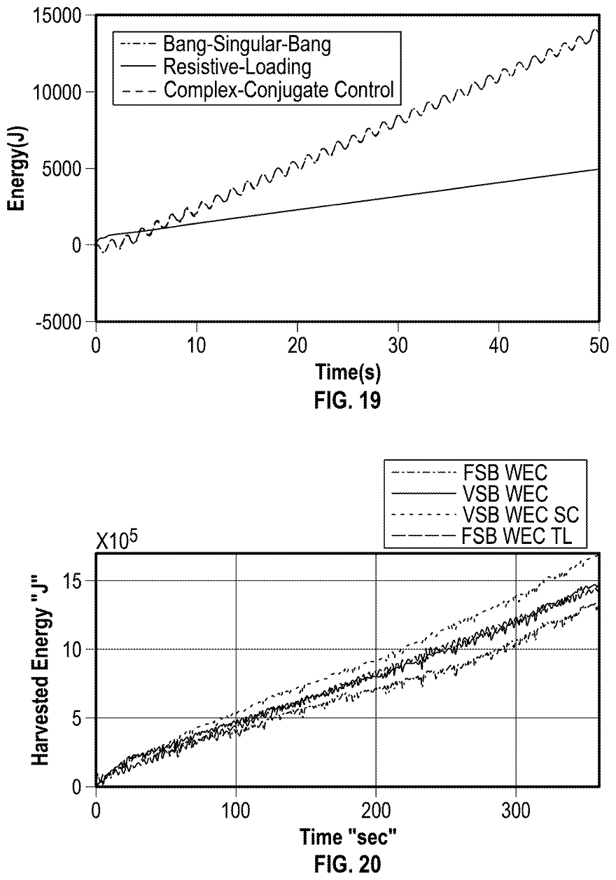

FIG. 19 presents a sample result (Zou 2017) from where the BSB control harvests about the same energy as the theoretical maximum limit (complex conjugate control). The harmonics shown in FIG. 19 for both the complex conjugate and the BSB controls indicate that both controls require bidirectional power flow capability. It is also shown that the energy harvesting rate is significantly higher than the Resistive-Loading control which is a benchmark control approach that does not need bidirectional power flow capability (there are no harmonics in the energy curve.) The latter control can be implemented using a relatively simple PTO, but produces significantly less power.

When using a flexible wave energy converter, the optimal control that would generate maximum harvested power from the ocean is developed in co-invented Shabara et al., “Optimal control of variable-shape wave energy converters,” in IEEE Control Systems Letters, vol. 7, pp. 1333-1338, 2023; which is hereby incorporated by reference in its entirety herein. Some of the numerical simulation results are highlighted in Shabara et al. “Dynamic modeling of the motions of variable-shape wave energy converters,” Renewable and Sustainable Energy Reviews, vol. 173, p. 113070, 2023; which is hereby incorporated by reference in its entirety herein.

In particular, the following example is a benchmark that highlights the advantage of a flexible wave energy converter over a rigid wave energy converter. Considering two wave energy converters of same size for simplicity of presentation, they are assumed to be simple spherical heavings wave energy converters: a concept that is different from oscillating water columns, but the control derived for one concept is applicable to the other concept.

For the flexible device, two models are tested: (1) no control on the elastic material shape, and (2) optimally controlled shape using distributed piezoelectric actuators/harvesters. The deformation is controlled actively depending on the wave conditions; the shape motion is represented in the form of mode shapes. The control laws determine the amplitudes of the mode shapes that give the optimal shape. The modulus of elasticity of the rigid device is 10 GPa compared to 1 MPa for the flexible device, the material Poisson's ratio is ν=0.3. Assuming a Bretschneider Spectrum, with a significant wave height and peak wave period of 0.8222 m and six seconds (6 sec), respectively. The number of frequencies used in simulation is 256. A simulation for 360 seconds is conducted. Numerical results are shown in FIG. 20. In FIG. 20, the “VSB WEC SC” denotes the shape-controlled flexible WEC, The “VSB WEC” denotes the flexible WEC without shape control, “FSB WEC” denotes the rigid WEC, and “FSB WEC TL” denotes the maximum theoretical limit of the rigid WEC.

Simulations show that the harvested energy from the flexible device without and with shape control increased over that of the rigid device by 11% and 26.9%, respectively. Also, the flexible device harvests almost the same amount of energy as the theoretical limit of the rigid device. It is important to highlight that the harvested energies of the flexible device (with and without shape control) are higher than that of the rigid device even though the velocities are less; this is due to the continuously changing shape of the elastic material. Being able to capture more power with about the same velocity level is indeed a new phenomenon in wave energy conversion. This can be further justified using FIG. 21 in which there is a reduction in the reactive powers for the flexible device of 17.4% and 11.9% for the cases of shape control and no shape control, respectively, compared to the rigid device.

To provide an insight into the efficiency of the flexible device compared to the rigid one, the capture width ratio (CWR), for the three devices in this simulation, was calculated based on Abdelkhalik et al., October 2017, “Multi Resonant Feedback Control of Three-Degree-of Freedom Wave Energy Converters”, IEEE Transactions on Sustainable Energy, Vol. 8, No. 4, pages 1518-1526; which is hereby incorporated by reference in its entirety herein.

If the mean absorbed power by the device is Pm(W), and the wave energy transport Pw (W/m) is given by:

$${P}_{W} = \frac{1}{2} ρ g {\int }_{{ω}_{m i n}}^{{ω}_{ma x}} \frac{S ( ω )}{ω} d ω$$

where S(ω) is the wave spectrum at frequency ω. Then the CWR for irregular waves is defined as:

$$CRW = \frac{{P}_{m}}{{P}_{w} D}$$

where D is the device characteristic length. The CWR of the rigid device is 0.15. For the flexible device without shape control, the CRW is 0.19, and for the flexible device with shape control the CRW is 0.21. Clearly the flexible device has a significantly higher capture width ratio.

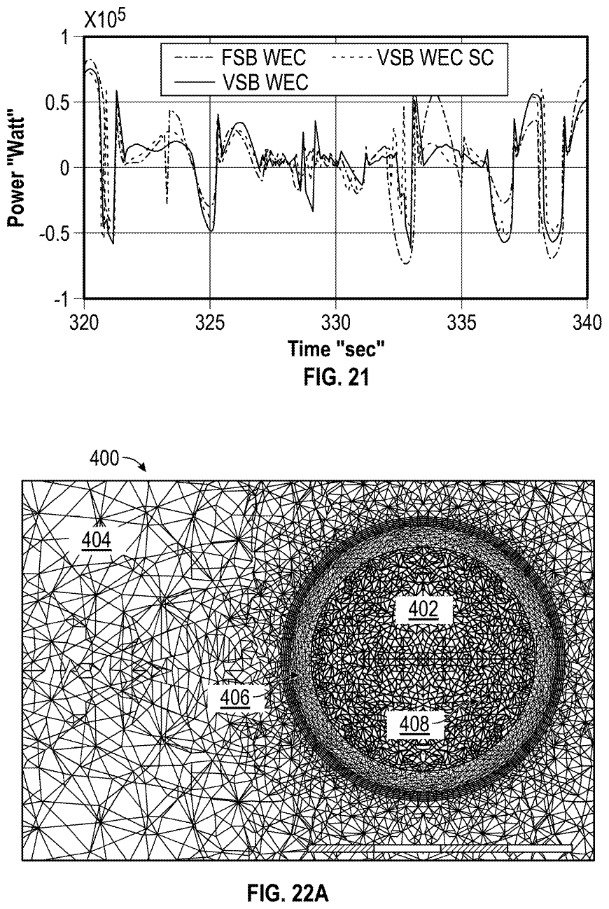

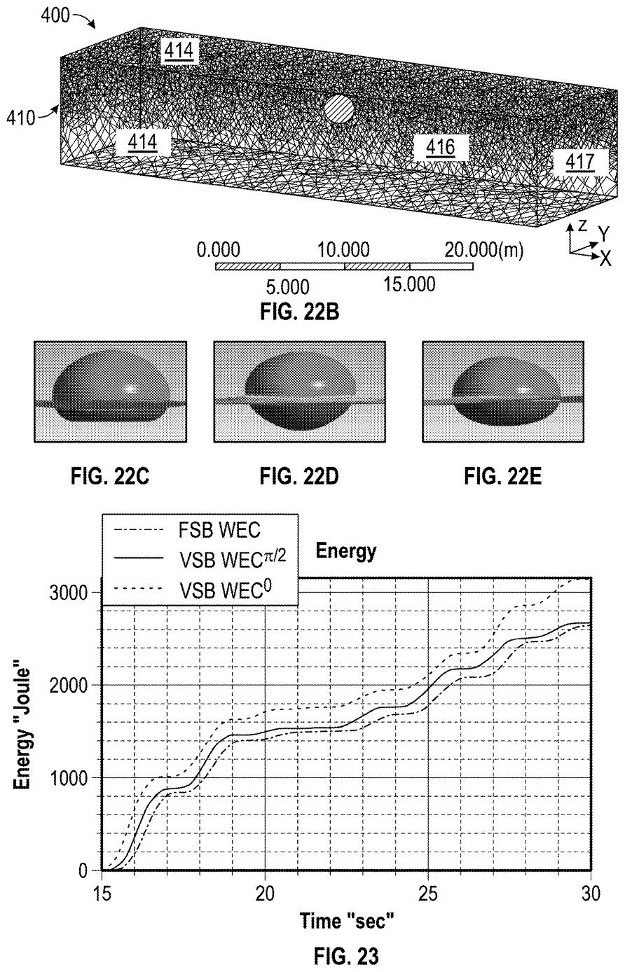

Flexible devices generate significantly more power compared to rigid devices. High fidelity simulations were also conducted. A numerical wave tank 400 is developed using ANSYS for high fidelity simulations, as shown in FIGS. 22A-22E. The numerical wave tank 400 shows an internal fluid domain 402, a surrounding fluid domain 404, a deform face out 406, a deform face in 408, a velocity inlet 410, a pressure outlet 412, symmetries 414, and a free surface 416.

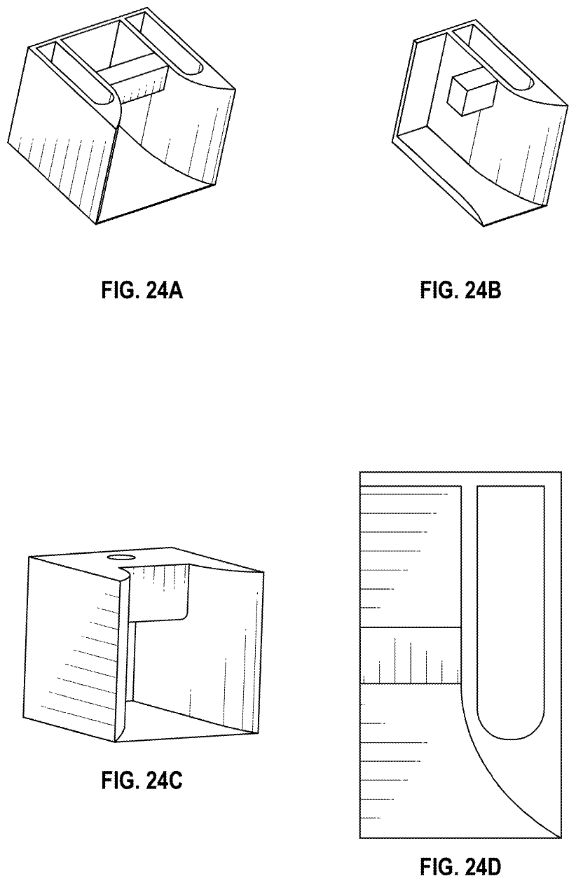

The results of the high fidelity simulations for a case study of a flexible heaving sphere are presented in in FIG. 23 where it is demonstrated that the kinetic power of a flexible sphere (VSB WEC^{π/2} and VSB WEC⁰ in FIG. 23) is higher than that of a rigid sphere (VSB WEC in the figure) of the same size; despite that both have the same range of velocities. In conducting these numerical simulations on a scale sphere, a control force was assumed to be only damping control with no reactive power term in the control force.

### Commercialization & Testing of a Flexible Oscillating Water Column

A commercial device that converts energy from waves should incorporate an effective design process based on reliable mathematical/numerical models and validating experimental data. The two main criteria for wave energy design are (a) hydrodynamic absorption design; and (b) extreme wave force design. See e.g., Paduano et al., April 2024 “Towards standardized design of wave energy converters: A high-fidelity modelling approach.” Renewable Energy. Only then should the device be used in open waters. Current strategies known in the art, such as those described in Horvath, 2009, “Wave loading at coastal wave energy converters” Edinburgh: MSc dissertation, University of Edinburgh, fail often. There have been too many preventable failures that have shut down some excellent technical pioneers in this domain.

Regarding hydrodynamic absorption design, there has been a lot of work in shape optimizing the oscillating water column, in fact too much to mention. The goal of the commercial product is to rigorously test and provide at least one robust oscillating water column configuration that is suitable for a coastal concrete caisson structure. This generated data would then be used to verify the numerical models. Once verified and validated these numerical models can then be adapted to change design parameters within some restrictions. Generative accurate and valid experimental data is of extreme importance.

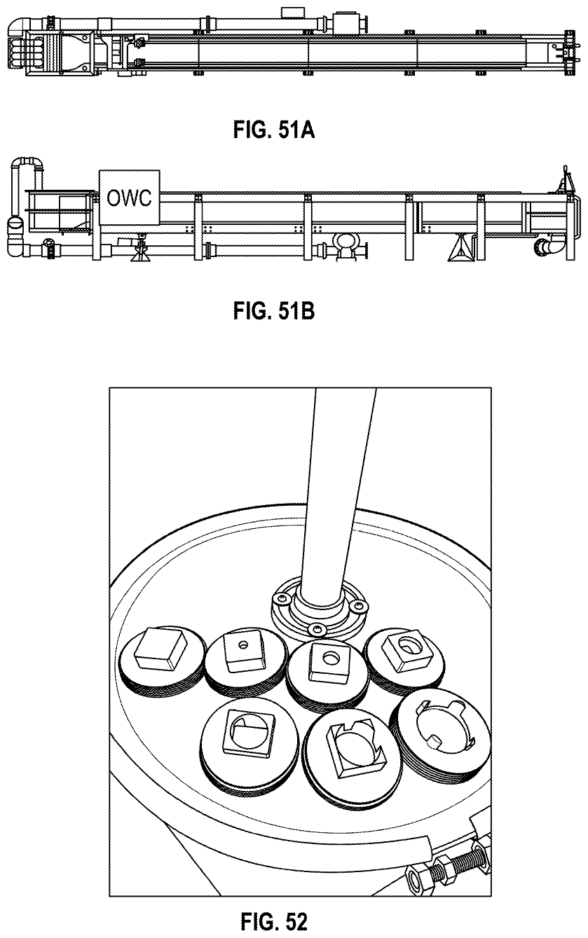

Froude Scaling. It is usual to test devices in the laboratory test-tank facilities at 1:15 to 1:50 scale model ratios. One example wave flume that can be used for testing is the University of Iowa wave flume (see e.g., FIG. 51A and FIG. 51B, described in further detail infra). The wave flume has a width of 0.6 meters and a water depth 0.8 meters. A model ratio of 20 can be used for testing. The most important non-dimensional parameter used to model waves is the Froude number which implies that the time scale is the square root of the model scale.

FIGS. 24A-24D show a design of the 1:20 oscillating water column scaled model breakwater unit for the 600 mm wide wave flume. The water depth at full scale is the reference 10 meters. The oscillating water column has a bottom box one meter high at full scale and 500 mm at model scale. Testing such a device spanning the entire width of the flume is equivalent to an array of devices as the flume side walls acts as mirror planes. So, these results obtained will be applicable to a coastal structure with infinite such devices spanning in both directions. The small waves that normally occur during most of the life of the device are of most interest, as the goal is to evaluate hydrodynamic absorption.

Incident and Reflection Measurement and Quantification. Coastal structures are generally built to protect the lee side but also might have to cater to ship traffic in front of it hence the reflection from these structures is also an important design criterion to understand. To understand this design parameter, a very detailed incident was done that reflected wave calculation going towards the device and reflecting away from the device. The incident was done using multiple wave probes spaced optimally whose signals are Fourier decomposed to estimate magnitudes of waves in the two directions. See e.g., Mullen et al., March 2023, “A Study of Multiple Wave Probe Methods to Resolve Wave Reflections.” SNAME 28th Offshore Symposium. Houston, Texas: SNAME; which is hereby incorporated by reference in its entirety herein.

Energy Balance. This gives the option of conducting an energy balance of the energy going into the device and the energy reflected from the device. A damping mechanism is used to evaluate the power absorbed by the device. The energy balance describes how much energy is unaccounted for. See e.g., Mullen, et al., 2023, “Wave Energy Converter Integrated with Breakwater: Experimental Investigation of Hydrodynamic Efficiency.” OCEANS. Gulf Coast; which is hereby incorporated by reference in its entirety herein.

Modelling Turbine. At model scales, it is impractical to use a turbine to convert wave energy hence using a damper to represent the turbine is accepted practice. Porous membranes are generally used and accepted to represent a linear turbine at the model scale. Depending on the turbine, a linear approximation may be applicable. For nonlinear turbines, an orifice plate is adopted with varying hole diameters.

Air Compressibility. Another important parameter to model in hydrodynamic absorption design is air compressibility. Once Froude criteria were used to model waves it is impossible to satisfy air compressibility scaling at the same time. Froude scaling requires geometric similarity of all dimensions below water interacting with waves. Hence air volume ratio of model to prototype must be scaled to the square rather than the cube as would be expected based on Froude criteria. See e.g., Gionet-Gonzales et al., 2023, “Pulsating Power Extraction from an Oscillating Water Column.” Proceedings of the OCEANS 2023 Conference. Only the air chamber volume ratio is scaled to square, all volumes below water where waves interact are scaled to the cube as required in Froude law.

Experimental Viability. The goal is to run the model for at least 10 sinusoidal wave frequencies, 6 damping and 2 normally occurring wave amplitude, totaling 120 experimental runs. This experiment is repeated multiple times to get a good statistical estimate with high confidence. The experiments are expected to have at least 300 experimental runs. Combined with energy balance there should be a solid set of experimental data that will then be verified and validated using numerical models. A couple of irregular wave tests will be run to check combining sinusoidal test. Due to flume length restrictions, irregular runs should not be relied on too much.

Flexible and Numerical Models. Experimental modeling of a flexible oscillating water column satisfying both the Froude scale for waves, compressibility for air, and elasticity for flexible elements is novel. Individual elements of the flexible oscillating water column have been studied and are discussed, infra. BEM codes are used, such as WAMIT. Codes such as NEMOH are not working well for oscillating water column moonpool devices. Open source OpenFOAM and proprietary codes such as ANSYS Fluent, Star CCM and Flow3D can also be used.

If an experimental/commercial plan is executed and the resulting numerical simulations vetted with experimental data demonstrate at least 10% increase in harvested power of the flexible oscillating water column compared to a standard oscillating water column of same size, for a typical coastal site, this indicates a successful design.

### Extreme Wave Force Design

Combined with preliminary numerical simulations from above, a parametric design space can be spanned by narrowing the design(s) to be selected for thorough testing from two devices side by side at double the scale in a wave tank, thereby giving additional parameters that can be controlled to help with the economics of power production.

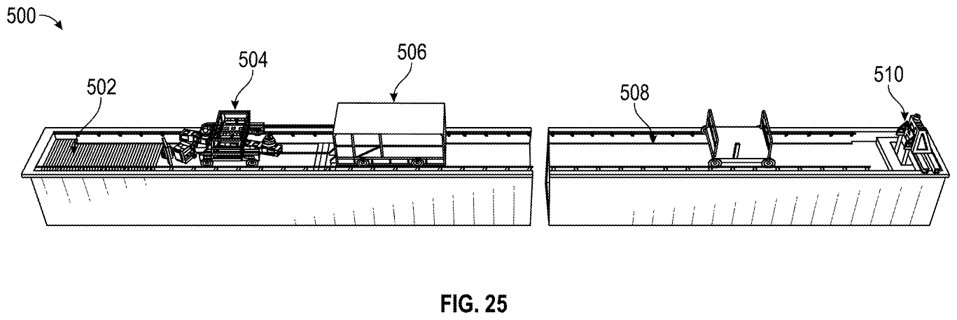

Force Evaluation. One of the key differentiators between the flexible oscillating water column and the extreme wave force design is that that a similar model is tested at 1:10 scale, twice the size of that in the flexible oscillating water column. These tests will be in the larger towing tank 500 (also referred to as model 500) shown in FIG. 25. The towing tank includes a beach 502, a planar motion mechanism (PMM) carriage 504, an instrumented drive carriage 506, wave dampers 508, and a wavemaker 510.

The beach 502 simulates a coastal area of a large body of water. The beach 502 can comprise a shallower depth than other fluidic areas included within the towing tank 500.

The planar motion mechanism 504 is a system that confines all its movement to a single, two-dimensional (x-y) plane, meaning all points on the mechanism remain on the same plane during motion. Planar mechanisms are generally easier to analyze and synthesize than spatial mechanisms due to their two-dimensional nature, and this can help give technical insight into the theory that affects the practical performance of a full scale breakwater 200 or flexible oscillating water column 300 in real world applications. The instrumented drive carriage 506 is operationally attached to the planar motion mechanism 504 and is used to position equipment or instruments in a controlled manner, or for simulating ocean conditions in a laboratory setting.

The wave damper 508 is a vibration damper that reduces or prevents vibratory motion by dissipating energy thus lessening the amplitude of vibrations and preventing damage or discomfort. In other words, the wave damper 508 acts as a vibration absorber, reducing the amount of energy transmitted through a system. The wave damper 508 reduces the amplitude of vibrations, meaning the oscillations become smaller and eventually stop. In some embodiments, the wave damper 508 converts mechanical energy into thermal energy.

The wavemaker 510 simulates realistic wave conditions in a physical model or numerical tank for research, port/harbor design, and coastal protection, allowing engineers to study wave-structure interactions and other phenomena. The wavemaker 510 can be critical for creating controlled wave environments in wave flumes or numerical tanks to study various aspects of oscillating water, such as waves and other typical movements of water within an ocean. The wavemaker 510 is not limited to being any particular type. For example, the wavemaker 510 can be (1) the piston-type: wherein a paddle moves horizontally to generate waves, suitable for shallow water applications; (2) a flap-type, wherein a hinged flap moves vertically to create waves, suitable for both shallow and deep water; and/or (3) a plunger-type, wherein a vertical plunger moves to generate waves, also suitable for both shallow and deep water.

In some embodiments, the wavemaker 510 generates regular waves. In other embodiments, the wavemaker 510 generates irregular waves and/or a combination of regular and irregular waves.

The PMM establishes numerical values for the hydrodynamic stability derivatives needed to quantify the directional stability of the model 500. The planar motion, for example, can be realized through linkages, which are rigid bodies (links) connected by joints that allow relative motion.

The expected results of these tests are to better understand scaling laws and to evaluate force loading due to actual geometry above still water line. At small scales force measurements, its scaling to a prototype might not be accurate. Viscous flow CFD code is used to evaluate forces. Linear BEM codes were acceptable for linear waves for wave absorption but not for no linear force computations.

All the nuances of the flexible oscillating water column, scaling laws for waves (Froude criteria), air compressibility, elastic deformation of membranes, energy balance to guarantee accuracy of experiments will be maintained.

This enables comparison of scaling laws from 1:20 to 1:10 exactly twice the size. The number of experimental parameters runs in extreme force wave design will be an order of magnitude more than the flexible oscillating water column. Irregular wave tests were run as tank will be twice the length and flexible oscillating water column restrictions would not apply as much. The result is a generic design that can be tuned to any wave climate along the coast close to the reference water depth.

Design Methodology. Using the experimental results and the verified and validated numerical models a methodology for a generic wave absorbing coastal design at typical sites was developed. This methodology will form the basis of the commercialization strategy. This knowledge of wave absorbing coastal structural designs enables construction companies to build such devices. After the extreme force wave design was finalized, one unit of the design was tested using for wet open water testing at pre-permitted sites, and shallow water sites in particular were explored.

### Flexible OWCs: Numerical Proof of Competitive Advantage

The concept of flexible point absorbers was originally introduced to address the bidirectional power generation challenges posed by PTO systems. See e.g., Shabara et al. “Dynamic modeling of the motions of variable-shape wave energy converters,” Renewable and Sustainable Energy Reviews, vol. 173, p. 113070, 2023; and Shabara et al., “Optimal control of variable-shape wave energy converters,” in IEEE Control Systems Letters, vol. 7, pp. 1333-1338, 2023; each of which is hereby incorporated by reference in its entirety herein. A similar approach was later adapted for oscillating water columns (OWCs). The present disclosure presents a proof-of-concept study on a flexible oscillating water column, demonstrating its potential to enhance power output by over 16%. The study employs a generator control optimized for a fixed oscillating water column, which is suboptimal for the flexible oscillating water column. Despite this suboptimal control, results indicate that the flexible oscillating water column significantly outperforms traditional oscillating water columns in terms of electrical energy production.

The fixed oscillating water column model in the present disclosure assumes the water behaves as a rigid body with a density equal to that of water, with its top surface positioned at the free surface. The system consists of three additional components: an air chamber, a flexible membrane, and the turbine-generator assembly.

Cummins Equation. The motion of the oscillating water column is governed by Newton's second low which can be expressed as:

m\ddot{x}(t)+Kₕₛx(t)=Fₑₓₜ+F_{rad}+F_{ch}

where x(t), \dot{x}(t), \ddot{x}(t)∈R are maps for the system's heave displacement, velocity and acceleration states, respectively. R is the set of real numbers, m∈R is the water column mass matrix, and Kₕₛ∈R is the hydrostatic coefficient. The hydrodynamic radiation force is calculated as:

$${F}_{r a d} = - {m}_{∞} \ddot{x} ( t ) - {\int }_{0}^{t} {K}_{r a d} \dot{x} ( t - τ ) d τ$$

where K_{rad}∈ [symbol] is the hydrodynamic radiation retardation function. For regular waves the convolution in the hydrodynamic function can be expressed as cx where c∈R is the radiation damping coefficient. F_{ch}=−A_{ch}Δp is the air chamber force acting on the water column, A_{ch}∈ [symbol] is the surface area of the water column, and Δp is the air chamber gauge pressure Δp=p_{ch}−pₐₜₘ, finally, p_{ch} and pₐₜₘ∈ [symbol] are the air chamber absolute pressure and the atmospheric pressure respectively.

Air Chamber Equation. The air chamber is bounded from below by the oscillating water column which acts as a piston in the current model, the equation of the air chamber is expressed as:

$$Δ \dot{p} = - ( Δ p + {p}_{atm} ) γ ( \frac{{\dot{V}}_{c h}}{{V}_{c h}} + \frac{{w}_{turb}}{{m}_{c h}} )$$

where y∈ [symbol] is the air specific heat, w_{turb}∈ [symbol] is the turbine mass flow rate, and m_{ch}=ρ_{ch}V_{ch} is the air chamber mass. For an air chamber connected in parallel to the turbine, the air chamber volume V_{ch}∈ [symbol] is expressed as:

V_{ch}=V₀−A_{ch}x(t)+V_{membrane}

where V₀∈ [symbol] is the air chamber initial volume, and V_{membrane}∈ [symbol] is membrane displaced volume.

Membrane Equation. There are two design options for the membrane: circular or rectangular. The equations of motion for the forced vibration of the rectangular membrane are derived. The equation of motion of forced vibrations of a rectangular membrane can be expressed as:

$$- P [ \frac{{\partial }^{2} w ( x , y , t )}{\partial {x}^{2}} + \frac{{\partial }^{2} w ( x , y , t )}{\partial {y}^{2}} ] + ρ \frac{{\partial }^{2} w ( x , y , t )}{\partial {t}^{2}} = F ( x , y , t )$$

where w∈ [symbol] is the membrane deformation in the vertical direction of the membrane local reference frame, ρ∈ [symbol] is the membrane density, P∈ [symbol] is the tension on the membrane. The equation of motion of forced vibrations of a rectangular membrane can be solved using the modal analysis procedure, and the solution can be expressed as:

$$w ( x , y , t ) = {\sum }_{m = 1}^{∞} {\sum }_{n = 1}^{∞} {W}_{m n} ( x , y ) {η}_{m n} ( t )$$

where Wₘₙ(x, y)∈R represents the system's normal modes corresponding to the mode shapes for m, n∈ [symbol] and ηₘₙ(t) is the generalized coordinates. For a membrane with clamped boundaries, the eigenfunction normal mode can be expressed as:

$${W}_{m n} ( x , y ) = \frac{2}{\sqrt{ρ a b}} sin \frac{m π x}{a} sin \frac{m π y}{b}$$

where a, b∈ [symbol] are the rectangular membrane side lengths. Substituting w(x,y,t) into F(x,y,t), then multiplying by w(x,y,t) then integrating with respect to the membrane surface area yields:

$${\ddot{η}}_{m n} ( t ) + {ω}_{m n}^{2} {η}_{m n} ( t ) = {N}_{m n} ( t )$$

where the membrane natural frequency is expressed as:

$${ω}_{m n} = π \sqrt{\frac{P}{ρ} [ {( \frac{m}{a} )}^{2} + {( \frac{n}{b} )}^{2} ]}$$

and the generalized external force Nₘₙ(t) is expressed as:

$${N}_{m n} ( t ) = {\int }_{0}^{a} {\int }_{0}^{b} {W}_{m n} ( t ) f ( x , y , t ) dydx$$

For a membrane with clamped boundary, it can be shown that:

$${η}_{m n} ( t ) = \frac{1}{{ω}_{m n}} {\int }_{0}^{t} {N}_{m n} ( t ) sin {ω}_{m n} ( t - τ ) d τ$$

To avoid the calculation of the convolution in the equation above the following assumptions are made. Assumption 1: The force acting on the membrane is assumed to be quasi-static, meaning that f(t) is approximated as fᵢ at each time step, where fᵢ is the instantaneous force on the membrane at the i^{th} time step. Assumption 2: The membrane force acts as a point force on the center point of the membrane surface area.

$${f}_{i} ( x , y ) = {F}_{i} ( x - \frac{a}{2} , y - \frac{b}{2} )$$

where

$$δ ( x - \frac{a}{2} , y - \frac{b}{2} ) = f ( x ) = \{ \begin{matrix}0 , & if x \neq \frac{a}{2} and y \neq \frac{b}{2} \\ 1 , & {\int }_{0}^{a} {\int }_{0}^{b} δ ( x - \frac{a}{2} , y - \frac{b}{2} ) dxdy = 1\end{matrix}$$

Thus, the generalized external force Nₘₙ(t) can be expressed as

$${N}_{m n} ( t ) = {f}_{i} {\int }_{0}^{a} {\int }_{0}^{b} {W}_{m n} ( x , y ) dydx = \frac{2 {f}_{i}}{\sqrt{ρ a b}} sin \frac{m π}{2} sin \frac{n π}{2}$$

and ηₘₙ(t) becomes:

$${η}_{m n} ( t ) = \frac{{N}_{m n}}{{ω}_{m n}} {\int }_{0}^{t} sin {ω}_{m n} ( t - τ ) d τ = \frac{1}{{ω}_{m n}^{2}} \frac{2 {f}_{i}}{ρ a b} sin \frac{m π}{2} sin \frac{n π}{2} ( 1 - cos ω t )$$

and its time derivative is computed as:

$$\dot{η} ( t ) = \frac{1}{{ω}_{m n}^{2}} \frac{2 {f}_{i}}{ρ a b} sin \frac{m π}{2} sin \frac{n π}{2} sin ω t$$

Substituting \dot{η}(t) into Wₘₙ(x,y) and w(x,y,t) yields:

$$w ( x , y , t ) = {\sum }_{m = 1}^{∞} {\sum }_{n = 1}^{∞} \frac{4 {f}_{i}}{{ω}_{m n}^{2} ρ a b \sqrt{ρ a b}} sin \frac{m π x}{a} sin \frac{m π y}{b} sin \frac{m π}{2} sin \frac{n π}{2} ( 1 - cos ω t )$$

The displaced volume by the membrane and its rate of change are expressed as:

$${V}_{m e m b r a n e} = {\int }_{0}^{a} {\int }_{0}^{b} w dydx$$

$$= {\sum }_{m = 1}^{∞} {\sum }_{n = 1}^{∞} \frac{1}{m n {π}^{2}} \frac{4 {f}_{i}}{{ω}_{m n} ρ \sqrt{ρ a b}} sin \frac{m π}{2} sin \frac{n π}{2} ( cos m π - 1 ) ( cos n π - 1 ) ( 1 - cos ω t )$$

$${V}_{m e m b r a n e} = {\int }_{0}^{a} {\int }_{0}^{b} w dydx$$

$$= {\sum }_{m = 1}^{∞} {\sum }_{n = 1}^{∞} \frac{1}{m n {π}^{2}} \frac{4 {f}_{i}}{{ω}_{m n} ρ \sqrt{ρ a b}} sin \frac{m π}{2} sin \frac{n π}{2} ( cos m π - 1 ) ( cos n π - 1 ) ( sin {ω}_{m n} t )$$

Turbine Performance Curve and Equation. The Mutriku wave energy plant, situated in the Basque Country, Spain, began operations in 2011. It features 16 stationary oscillating water columns (OWCs), each initially fitted with a wells turbine and a generator, each with a rated capacity of 18.5 kW. In June 2017, under the EU-funded OPERA project, a biradial turbine and a 30 KW generator were installed on one of the oscillating wave column units to enhance performance. The Wells turbine and the generator used in the present disclosure are same as the one used in the Mutriku wave energy plant.

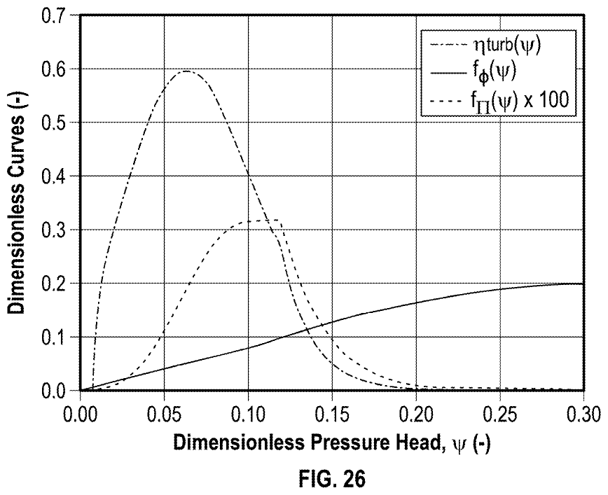

The turbine in this model is assumed to be rotating at the same speed as the generator, the turbine equation of motion assuming no fraction losses is expressed as:

$$\frac{d}{d t} ( \frac{1}{2} {I}_{turb} {Ω}^{2} ) = {P}_{turb} - u Ω$$

$$Ω = \frac{( {T}_{turb} - u )}{{I}_{turb}}$$

where T_{turb}∈ [symbol] is the turbine torque, u∈ [symbol] is the control torque, Ω∈ [symbol] is the GenSet rotational Speed, and I_{turb}∈ [symbol] is the turbine rotor moment of inertia. The turbine used in this paper is Wells turbine, the performance curves are function of the the dimensionless turbine mass flow rate Φ∈ [symbol] , dimensionless turbine power Π∈ [symbol] and the dimensionless turbine head Ψ∈ [symbol] expressed as:

$$Φ = \frac{{w}_{turb}}{{ρ}_{i n} Ω {d}_{r}^{3}} , Π = \frac{{P}_{turb}}{{ρ}_{i n} {Ω}^{3} {d}_{r}^{5}} , Ψ = \frac{Δ p}{{ρ}_{i n} {Ω}^{2} {d}_{r}^{2}}$$

where ρᵢₙ=max(ρ_{ch}, βₐₜₘ), and dᵣ∈ [symbol] is the turbine diameter. These values together with the turbine efficiency can be calculated using the equations above and the performance curves in FIG. 26.

Generator Equation and Control. The generator equation was provided in Silva et al., “GA-optimized inverse fuzzy model control of owc wave power plants,” Renewable Energy, vol. 204, pp. 556-568, 2023. The control method for u follows turbine energy maximization approach described in M. Rosati, H. A. Said, and J. V. Ringwood, “Wave-to-wire control of an oscillating water column wave energy system equipped with a wells turbine,” in Proceedings of the 15th European wave and tidal energy conference, 2023.

Main Results of Regular Waves. A circular air chamber is used with diameter of d_{ch}=5.89 m, and a rectangular membrane connected in parallel was used, the membrane side length is a=b=3 m, and the membrane density ρ_{membrane}=1300 kg/m³, and the tension on the membrane is P=1.6×10⁴, with only the diaphragm breaking mode enabled n=m=1. A regular wave was tested with Tₛ=11.2 s and Hₛ=4 m.

The main results is presented in Table 1, where it can be seen the effect of adding a membrane to the oscillating water column system positively impacting the energy output of the oscillating water column.

TABLE 1
Energy increases for different components
of the oscillating water column system.

| Parameter | Value |
|---|---|
| Increase in Generated Energy | 16.3396% |
| Increase in Turbine Energy | 13.6745% |
| Increase in Pneumatic Energy | 13.2942% |

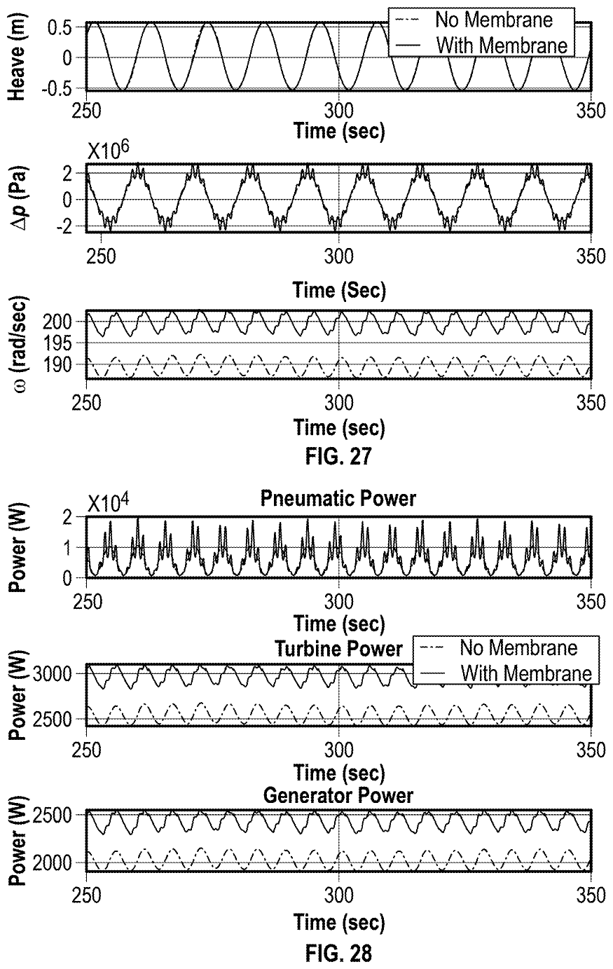

FIG. 27 shows the heave response of the oscillating water column, the air chamber pressure and the Gen-Set rotational speeds. The effect of the membrane can be seen in the turbine and speed and the air chamber pressure.

FIG. 28 shows the pneumatic, turbine power, and the generator powers of the oscillating water column with the membrane and without the membrane.

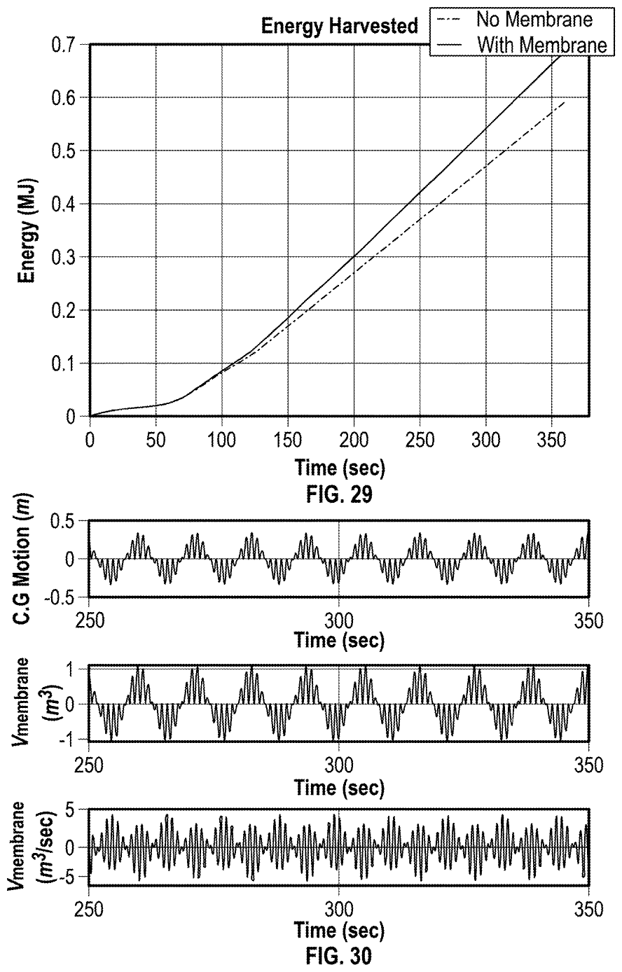

The generator energy output of the system is presented in FIG. 29. And FIG. 30 shows the membrane response.

Main Results of Irregular Waves. Irregular waves were generated using the Pierson-Moskowitz (PM) spectrum, characterized by a wave period of 11.2 seconds and a significant wave height of 4 meters. To adapt to these conditions, the membrane dimensions were slightly increased to a=b=3 m, while maintaining the same membrane tension as used in regular wave conditions. The increase in membrane size was intended to enhance energy harvesting, even from the smaller amplitude waves present in the irregular wave spectrum.

The summary of the irregular wave energy results is presented in Table 2, which shows the positive effect of adding a membrane to the oscillating water column system on energy output. The membrane was able to increase the total absorbed energy by 13.82%. However, since the same control parameters were used for both models (with and without the membrane), the increase in harvested energy from the pneumatic power by the turbine was limited to 2.75%, and the generator output increased by only 3.45%.

TABLE 2
Energy increases for different components of the oscillating
water column system in the tested irregular waves.

| Parameter | Value |
|---|---|
| Increase in Generated Energy | 3.4515% |
| Increase in Turbine Energy | 2.7498% |
| Increase in Pneumatic Energy | 13.8151% |

FIG. 31 shows the heave response of the oscillating water column, the air chamber pressure and the Gen-Set rotational speeds. The effect of the membrane can be seen in the turbine and speed and the air chamber pressure.

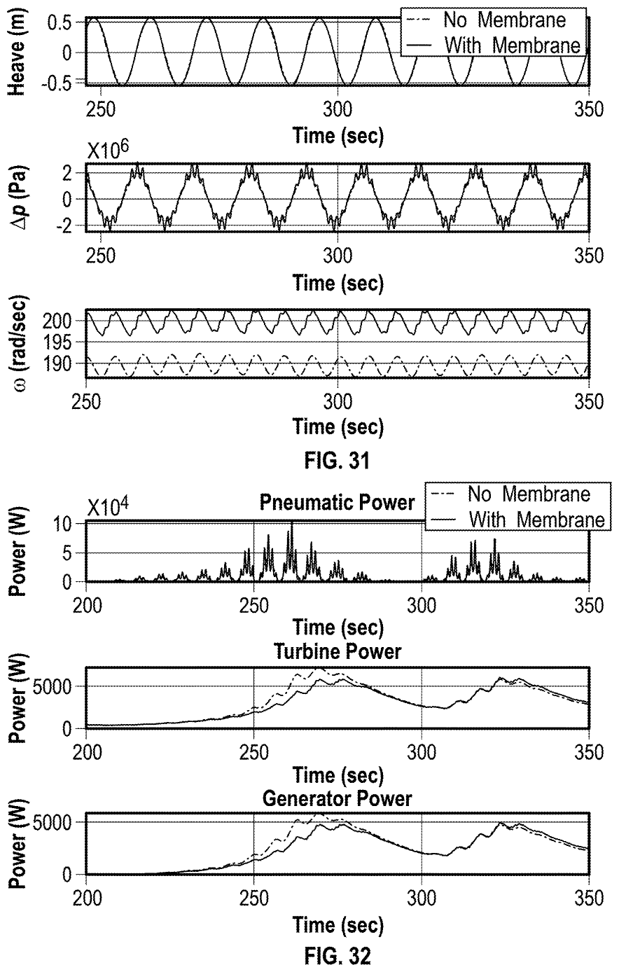

FIG. 32 shows the pneumatic, turbine power, and the generator powers of the oscillating water column with the membrane and without the membrane. It can be seen that there is a fast-varying frequency related to the membrane superimposed over the wave frequency response.

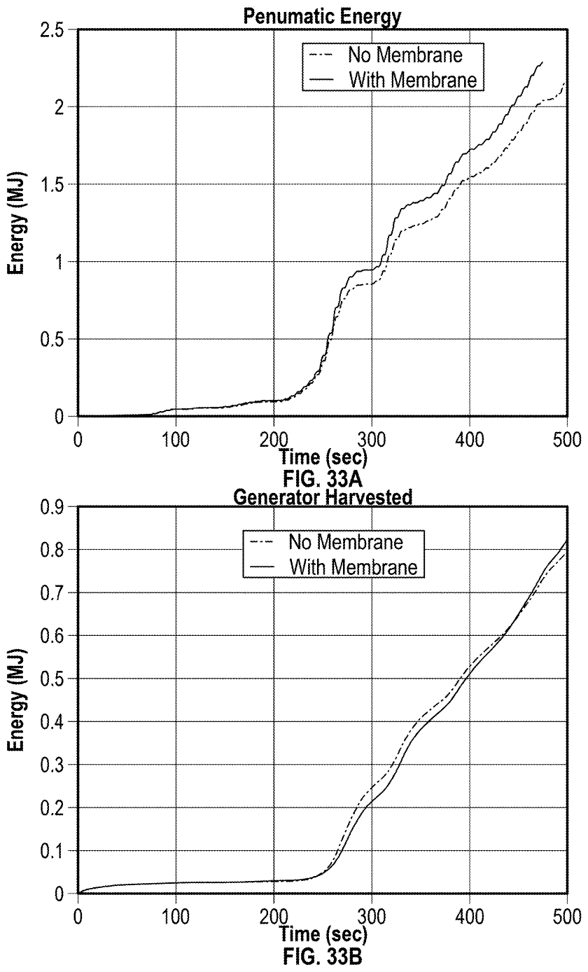

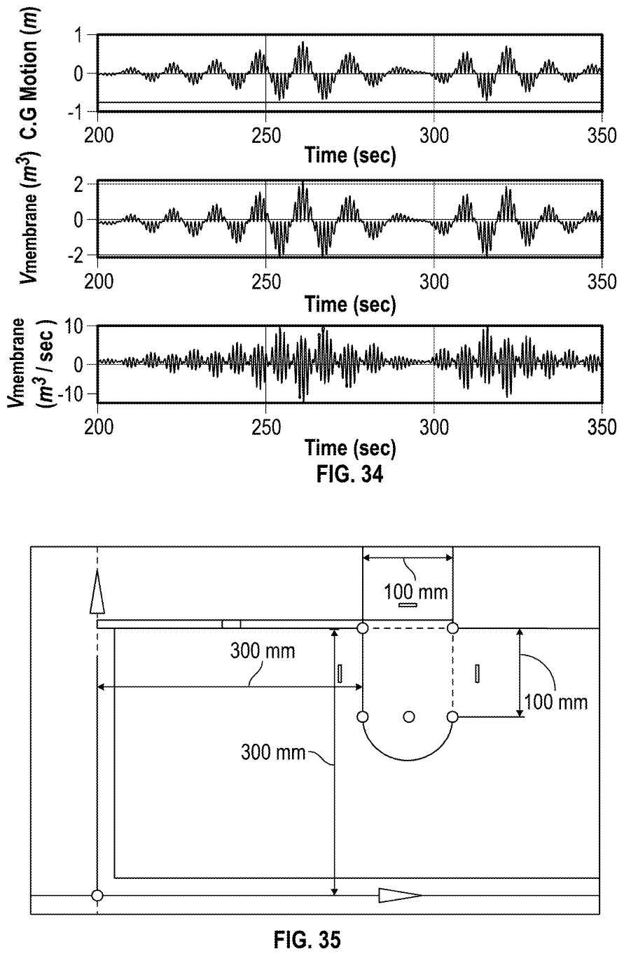

The pneumatic and generator energy output of the system is presented in FIGS. 33A-33B. And FIG. 34 shows the membrane response.

The displacement of the membrane's center of geometry, as well as the total membrane volume and its rate of change, are shown in FIG. 34. The membrane's center of geometry displacement is observed to be 0.81% of a meter. It is important to note that the membrane equations assume the pneumatic force acting on the membrane is concentrated at a single point, located at the center.

Conclusions. Increasing the flexibility of the membrane leads to greater energy harvesting. For irregular waves, the TEM control strategy used for the oscillating water column without the membrane should be revised to fully capture the capacity of the oscillating water column with the membrane. Removing the point force assumption would provide a more accurate representation of the membrane's response. Testing alternative membrane shapes (e.g., circular) could further optimize the performance of the oscillating water column system.

### Higher Fidelity Model of The FlexOWC

The concept of flexible point absorbers was originally introduced to address the bidirectional power generation challenges posed by PTO systems. A similar approach was later adapted for oscillating water columns. The present disclosure presents a higher fidelity proof-of-concept study on a flexible oscillating water column, demonstrating its potential to enhance power output. This study employs a Fluid-Structure Interaction model using OpenFoam.

Numerical Wave Tank Description. The numerical wave tank emulates a physical wave flume available in the US. The aim is to model a fixed bottom standing oscillating water column in a wave flume. FIG. 35 is a half symmetric oscillating water column model in a flume. The wave flume is about 300 mm high and 300 mm long in direction of the wave. It has an orifice opening at the middle of the top plate in the air volume. The water depth is 200 mm such that the lip (100 mm thick) is at the water level, the length of the tank in the x-direction is 15 meters length.

The 2-D modeling of oscillating water columns can provide good agreement with experimental data if a fine enough mesh was used. The numerical wave tank used in this work is a 2-D model, with an oscillating flap type wave generator and length of 15 meters. The membrane was modeled using an open-source library that is compatible with OpenFoam.

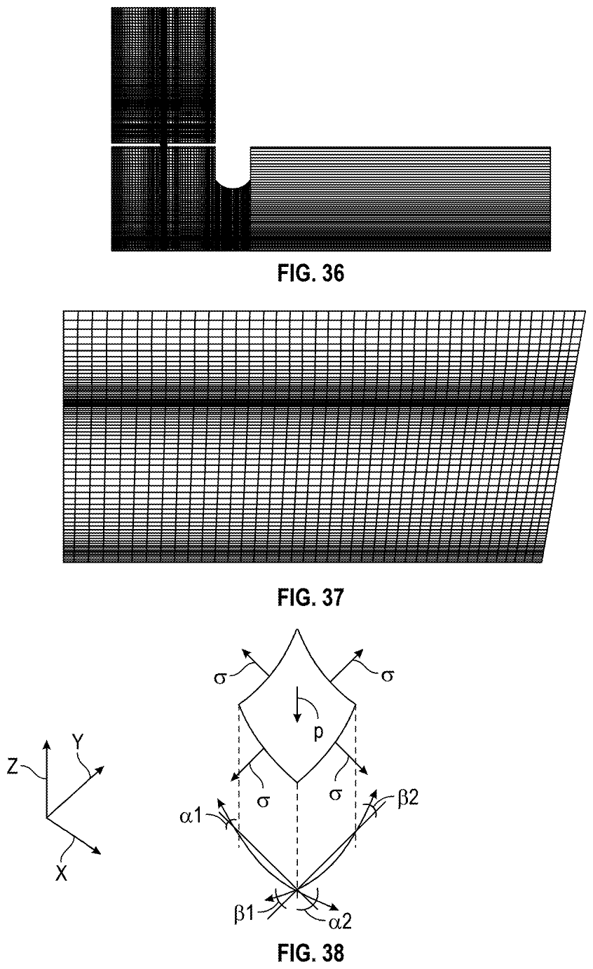

Mesh and dynamic mesh description. The multi-block mesh generator blockMesh was used to create the wave tank and define its boundaries. Mesh generation, also known as domain discretization, involves partitioning the physical space into a finite set of distinct regions. Unlike the geometry shown in FIG. 35 an exhaust air chamber is added to the numerical tank above the orifice to model the air flow behavior as it exits the oscillating water column air chamber as shown in FIG. 36. The mesh was refined near the walls to improve model stability and lower the y⁺ values, as shown in FIG. 37. Additionally, the mesh was refined at the anticipated free surface location. In the numerical wave tank, the curvature of the semi-circle shown in FIG. 35 was decreased by a factor of 0.5×, which reduced mesh skewness near that boundary, further enhancing both solution stability and accuracy.

The mesh quality and parameters are reported in Table 3. The dynamic mesh is needed in two regions, (1) the wave generator region and (2) the membrane region. In the present disclosure, a dynamic mesh approach was employed utilizing the dynamicFvMesh class, which allows for the adaptation of the computational mesh in response to changing geometries. The dynamicMotionSolverFvMesh object manages the motion of the mesh during the simulation, enabling advanced motion capabilities. For the displacement calculations, the displacementLaplacian solver was adopted, which provides a robust method for handling the displacement fields within the dynamic mesh framework. The displacement coefficients were defined to account for different geometrical features: the diffusivity was set as an inverse distance function allowing for mesh refinement near this boundary. This configuration effectively captures the dynamics of the fluid-structure interaction, leading to enhanced accuracy in the simulation results.

TABLE 3
Mesh and Domain Statistics

| Mesh Parameter | Value |
|---|---|
| Cells | 182,144 |
| Maximum Aspect Ratio | 22.1993 |
| Total Volume | 0.0460814 |
| Average Non-Orthogonality | 2.31983 |
| Max Skewness | 0.861588 |

Multiphase flow solution. OpenFOAM (Open Source Field Operation and Manipulation) is an open-source computational fluid dynamics (CFD) toolbox primarily used for simulating fluid flow problems. It provides solvers for a variety of fluid dynamics simulations, including single-phase, multiphase, and reactive flow systems. In particular, the interFoam solver in OpenFOAM is widely used for simulating two-phase flows with an interface, typically involving immiscible fluids such as water and air. This section will provide an overview of the theory behind the interFoam solver, the multiphase flow approach, and an introduction to a more advanced solver, etcx, which is a specialized multiphase solver.

Multiphase Flow in OpenFOAM. The interaction between these phases is typically governed by complex physical phenomena, including phase change, surface tension, and interfacial forces. In OpenFOAM, multiphase flow is handled using a variety of solvers and models, with the most common approach for flows with free surface is the Volume-of-Fluid (VOF) method, which is used in solvers like inter Foam.

Volume-of-Fluid Method. The VOF method is a popular technique used to track and locate the free surface or interface between different phases. It relies on a transport equation for the volume fraction, a, which represents the fraction of a given phase (e.g., water, air) in a computational cell. The VOF method ensures that the volume fraction a remains bounded between 0 and 1. The governing equation for a is:

$$\frac{\partial α}{\partial t} + ∇ \cdot ( U α ) = 0$$

where U is the velocity field. This equation is solved in conjunction with the momentum equation for the entire fluid domain, which accounts for the dynamic interaction between the phases. The equation above can be viewed as the conservation of the mixture components along the path of a fluid parcel. In the current work, the cells completely filled with water has α=1, and the cells completely filled with air α=0. At the interphase between the two fluids α∈(0,1).

The interFoam Solver. The interFoam solver is one of the key solvers in OpenFOAM for simulating two-phase flow problems. It specifically solves for incompressible, isothermal flow of two immiscible fluids, often air and water. The solver is based on the VOF method to track the interface between the two phases and solve for the velocity and pressure fields, to correctly capture the free surface of the fluid, the mesh should be refined at the free surface, which increases the computational cost of the solver.

Governing Equations. In addition to the equation above, the fundamental equations solved in interFoam are the continuity equation:

∇·U=0

where U is the velocity vector of the mixture.

The Navier-Stokes equation for incompressible flow is:

$$\frac{\partial ( ρ U )}{\partial t} + ∇ \cdot ( ρ U ⊗ U ) = - ∇ p + ∇ \cdot ( μ ( ∇ U + {( ∇ U )}^{T} ) ) + f$$

where μ is the dynamic viscosity, and f represents external forces (such as gravity). The pressure field p is calculated as part of the solution process. The fluid density ρ is defined as:

ρ=αρ₁+(1−α)ρ₂

Phase Interaction and Surface Tension. In the interFoam solver, the interface between the two phases is typically governed by a surface tension model, which is included as a force term in the Navier-Stokes equation. The interfacial forces are usually modeled using the Continuum Surface Force (CSF) approach, where the surface tension force per unit length Fₛₜ is given by:

Fₛₜ=σκn

where σ is the surface tension coefficient, κ is the curvature of the interface, and n is the unit normal vector to the interface.

*Derivation of the Equation of Motion for a 2D Linear Membrane. Consider a 2D linear membrane subjected to an initial tension, resulting in a pre-stress σ. Small deformations of the membrane are assumed, so the linearity assumption holds, and small displacements are worked with.

Let the displacement of the membrane at any point in the local coordinate system be denoted by w(x,y,t), where w is the deflection in the local z-direction, and x, y are the side lengths of the membrane element in the x-y plane.

The forces on an infinitesimal membrane element with side lengths dx and dy are analyzed in Cartesian coordinates. The equation of motion for this infinitesimal element can be written as:

$$m \frac{{\partial }^{2} w}{\partial {t}^{2}} = {\sum }_{i} {F}_{z , i}$$

where m is the mass of the infinitesimal element, F_{z,i} are the forces acting in the z-direction on the membrane element.

To compute the forces F_{z,i}, the internal stress in the membrane due to its pre-stress σ is considered, as well as any external loads acting on it. The internal forces in the membrane are generated by the tension σ, which acts along the plane perpendicular of the membrane.

For an infinitesimal membrane element, the forces along the boundaries of the element are summed, taking into account both the tension forces due to the pre-stress σ and any external loading due to the pressure p, thus:

$${\sum }_{i} {F}_{z , i} = - σ hdy sin {α}_{1} + σ hdy sin {α}_{2} - σ hdx sin {β}_{1} + σ hdx sin {β}_{2} - pdxdy$$

where h is the thickness of the membrane, αᵢ and βᵢ are the angles between the undeformed local sides and after deformation in the x and y directions respectively as shown in FIG. 38, p is any external loading per unit area in the z-direction.

Assuming the membrane deformation is small (the linear assumption), the angles of deformation αᵢ and βᵢ are small. Therefore, the following small angle approximation is used:

$$sin {α}_{1} \approx tan {α}_{1} = \frac{\partial w}{\partial x} , sin {β}_{1} \approx tan {β}_{1} = \frac{\partial w}{\partial y}$$

Because the dx and dy are small, it can be written:

$$tan {α}_{2} = \frac{\partial w}{\partial x} + \frac{\partial tan {α}_{1}}{\partial x} dx$$

$$tan {β}_{2} = \frac{\partial w}{\partial y} + \frac{\partial tan {β}_{1}}{\partial y} dy$$

Thus, ΣᵢF_{z,i} can be expressed as:

$$ρ dxdy h \frac{{\partial }^{2} w}{\partial {t}^{2}} = σ h \frac{{\partial }^{2} w}{\partial {x}^{2}} d x d y + σ h \frac{{\partial }^{2} w}{\partial {y}^{2}} d x dy - pdxdy$$

where ρ is the membrane material density. Dividing both sides by (h dxdy) in the equation above yields:

$$\frac{p}{σ} \frac{{\partial }^{2} w}{\partial {t}^{2}} = \frac{{\partial }^{2} w}{\partial {x}^{2}} + \frac{{\partial }^{2} w}{\partial {y}^{2}} - \frac{p}{σ h}$$

OpenFoam Implementation. The Finite Area Method (FAM) is a numerical technique used to discretize and solve two-dimensional differential equations. In the context of the problem, this method is applied to solve for the membrane's displacement, w. The regionFaModel provides the necessary functionality to map the solution of a three-dimensional mesh to a corresponding two-dimensional finite area mesh. Specifically, in this case, the solution is mapped of the pressure field p from the three-dimensional model to the finite area mesh.

The boundary conditions of the membrane are defined by an instance of the regionFaModel. This model extracts the pressure information from the membrane boundary and solves for the displacement of the membrane. The resulting displacement solution is then applied to the mesh, modifying its configuration accordingly. It is important to note that the displacement is applied in the direction normal to the surface of the undeformed membrane patch. This approach ensures that the boundary conditions can be effectively applied to surfaces with arbitrary orientations, providing flexibility in the application of the method.

Results. To date, only regular waves have been tested. The flap motion was calibrated to generate a wave height of 0.01 m and a wave period of 4 seconds, with a ramp time of 4 seconds applied to the flap motion.

The membrane parameters were fine-tuned to ensure an acceptable response. This tuning involved adjusting the membrane's material density, pretension stress σ, internal hysteretic damping and external pressure acting above the membrane.

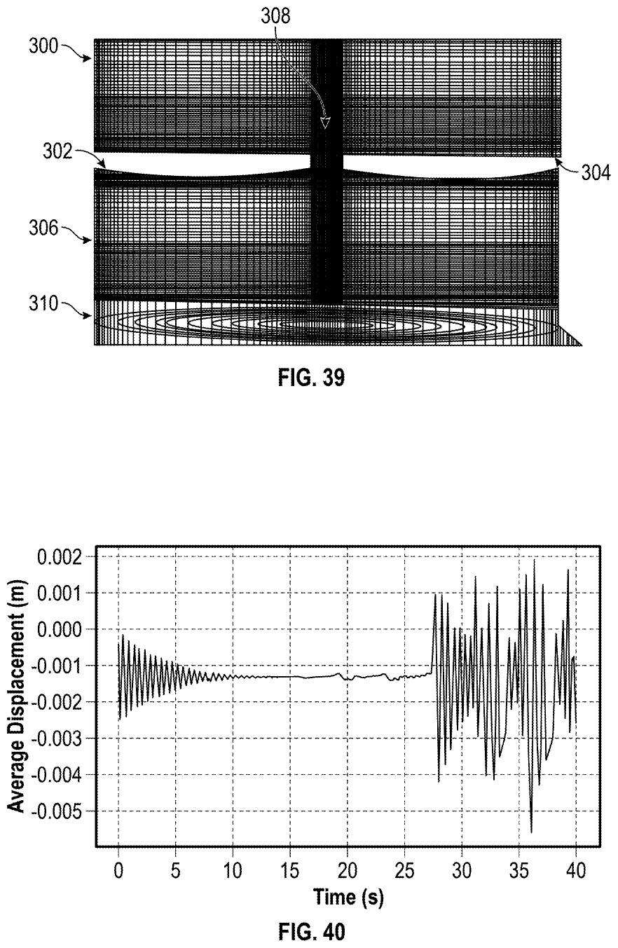

FIG. 39 illustrates the membrane orientation at t=40. The membrane was strategically positioned away from the free surface of the water, which significantly enhanced the stability of the numerical model.

The average displacement of the membrane is shown in FIG. 40. It can be seen that at the beginning of the simulation the membrane is not at the equilibrium position due to the applied pretension and external pressures, the membrane reached its steady state position after 10 sec.

The mass flow rate across the orifice is calculated using \dot{m}₀=A₀V₀, the area of the orifice A₀ is constant for both models (with and without the membrane), the velocity can be used an indication of the flow rate across the orifice. FIG. 41 shows the average flow velocity in the turbine.

### Numerical Analysis of an OWC Integrated Breakwater

In this section an oscillating water column (OWC) breakwater wall is analyzed using the commercial 3D potential flow code WAMIT.

WAMIT Version 7 is a radiation/diffraction three-dimensional panel method and program developed for the linear analysis of the interaction of surface waves with various types of floating and submerged structures. In addition to the conventional case where the bodies are rigid, and moving with six modes of rigid-body motion, WAMIT permits the analysis of generalized modes to represent devices for wave energy conversion. Part or all of the boundary surface can be defined as a free surface with an oscillatory pressure, as in the case of an oscillating water column. The flow is assumed to be ideal and time-harmonic. The free-surface condition is linearized. The radiation and diffraction velocity potentials on the body wetted surface are determined from the solution of an integral equation obtained by using Greens theorem with the free-surface source-potential as the Green function. WAMIT consists of two subprograms, POTEN and FORCE, which normally are run sequentially. POTEN solves for the radiation and diffraction velocity potentials (and source strengths) on the body surface for the specified modes, frequencies and wave headings. FORCE computes global quantities including the hydrodynamic coefficients, motions, and first and second-order forces. Velocities and pressures on the body surface are evaluated by FORCE.

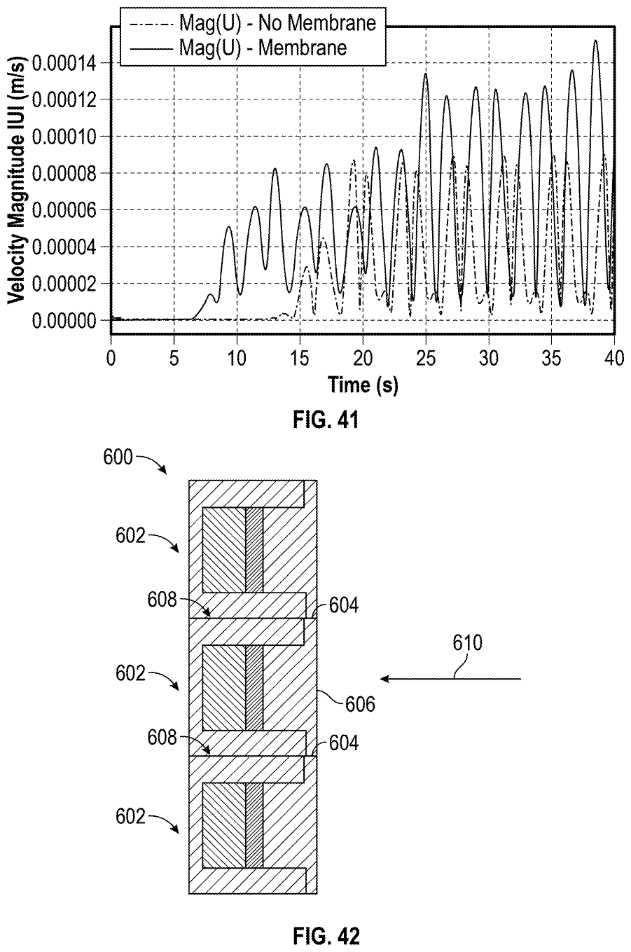

Numerical Modeling. A breakwater wall 600 that consists of repeating units of oscillating water columns 602 can be analyzed hydrodynamically as one oscillating water column unit 602 in a flume or channel 604 as shown in FIG. 42. The flume/channel walls 606 are equivalent to mirror planes that reflect the oscillating water column as an infinite series of units adjacent to each other simulating a very long wall. Since the goal is a multi-functional wall that can be used as real estate for other operations, capital costs can be shared to improve economics of energy production. The oscillating water column units 602 are spaced with gaps in-between with projecting walls known as harbor walls 608 that help concentrate wave energy from waves 610 to the oscillating water column units 602 and can also assist in increasing the resonant bandwidth characteristics of these cavity resonators.

To automate geometric variations, code was written to generate these geometries. Since WAMIT uses potential theory to model these devices viscosity is not considered and sharp edges and associated friction losses are ignored. The goal is to study and compare oscillating water column geometries and to compute device frequency responses of the exciting forces on the chamber free surface. WAMIT gives a good first computationally inexpensive scan of the geometric possibilities before computationally expensive computation fluid dynamics CFD tools are used.

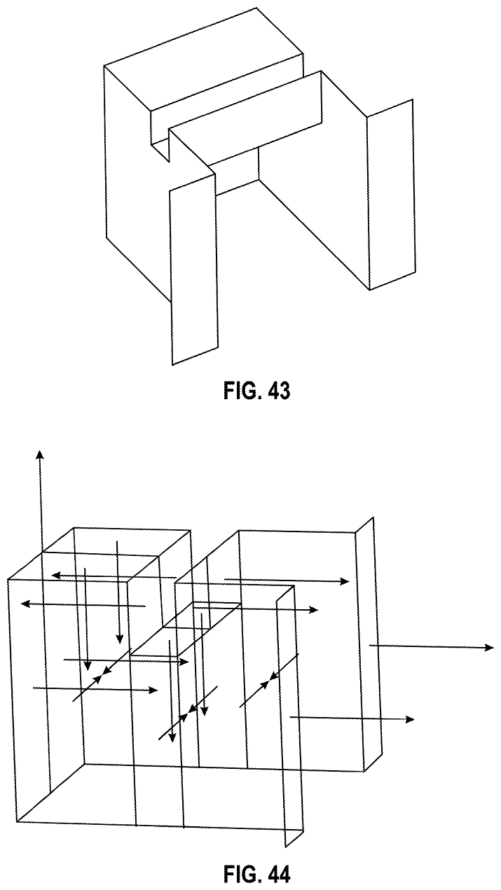

Only the surfaces that are wet need be modeled as shown in FIG. 43. The parametric variations studied are oscillating water column Length (OL), oscillating water column width (OW), Lip Width (LW), Lip Depth (LD), Harbor Wall Length (HL), and Harbor Half Width (HHW). Only the geometry below water line as required by the Linear Potential Flow solver WAMIT is shown in FIG. 43. The Water Depth (WD) is also a parameter that was studied for different potential wave energy sites.

FIG. 44 shows the 3D oscillating water column panels with normals pointing into fluid as required by WAMIT. This figure was generated using open-source package BEMRosetia-GitHub-BEMRosetia/BEMRosetia: Hydrodynamic coefficients viewer and converter for Boundary Element Method solver formats. The red arrow shows the positive X-Axis. Waves come into the device in the opposite direction. The origin is at the back of the oscillating water column with the blue Z Axis pointing upward, using the right-handed convention. The device is symmetric across the Y=0 plane.

The top of the oscillating water column free water surface is modelled as a pressure surface as is the state of the art in potential theory for oscillating water columns. For theory, please refer to the WAMIT manual.

Results. For the present disclosure the non-dimensional exciting force on the oscillating water column free pressure surface is computed as a generalized mode of oscillation in the heave direction, which is the vertical pumping mode for this cavity resonator. This force is normalized with ρ*g*A*L² where ρ is water density, g is acceleration due to gravity, A the wave amplitude and L² the area of the oscillating water column pressure surface panel.

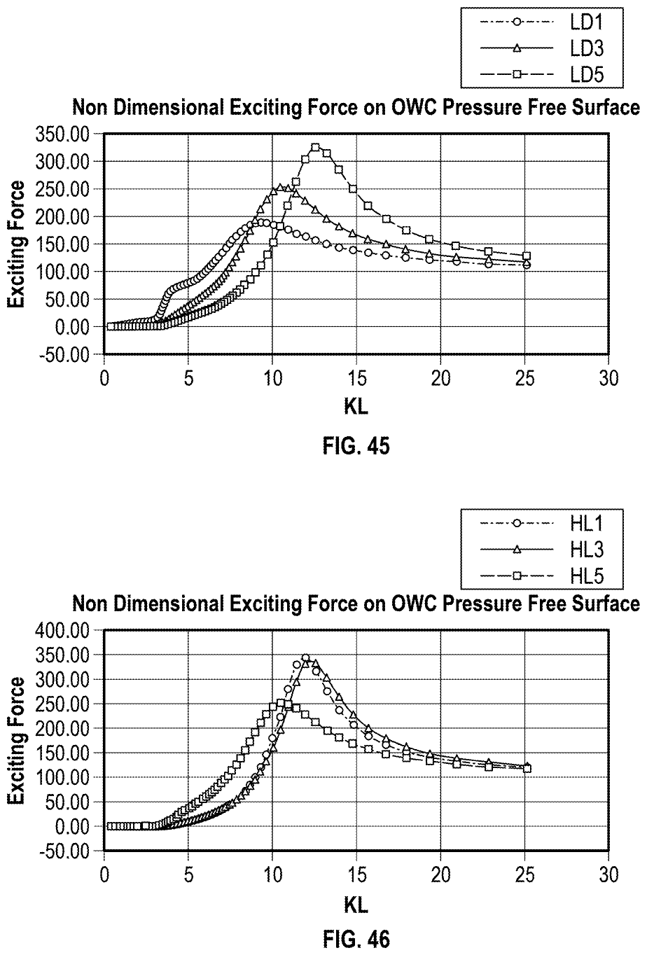

FIG. 45, shows the excitation force response inside oscillating water column free surface for different lip immersions, all other geometric dimensions held constant. As can be seen, deeper the Lip Immersion Depth (LD) the peak response shifts towards larger KL values where K is wavenumber and λ is the wavelength.

$$K = \frac{2 * Π}{λ}$$

Deeper lip immersion (DL1<DL3<DL5) is better for longer waves as these waves can enter the oscillating water column easier with larger particle motion at deeper depths. Also, the excitation magnitude is higher, as the long wave length with respect to the device (larger KL) is a horizontal surface producing a vertical piston motion inside the oscillating water column.

FIG. 46 shows the effect of Harbor Length (HL) (HL1<HL3<HL5) on the frequency response, all other geometric dimensions held constant. From these preliminary results it seems that the smallest Harbor Length tested HL1 has the best response. While harbors are known to increase resonances in independently standing devices, for the chosen breakwater configuration, they do not seem to help.

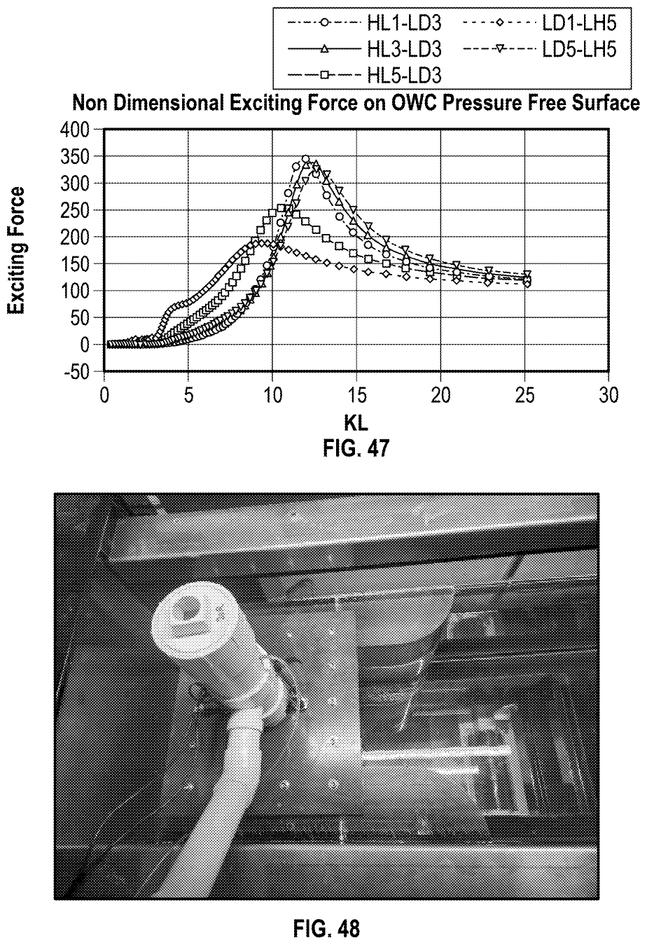

FIG. 47 shows all combinations tested so far in one graph for easier comparison. For the geometries tested Lip Depth LD3, with Harbor Length HL1, seems to have the best response. However, it should be noted that the KL value is slightly smaller for this geometry indicating better tuning to larger waves. This has implications for the size of the device and hence cost economics.

This methodology and results form design guidance for shallow water oscillating water column integrated breakwater structures. These parameters can be further tuned for specific site locations given the local wave spectra variations across the years.

### Customer Discovery Flexible Oscillating Water Column Report

The building of the oscillating water column provided significant opportunities for training and professional development. An 8-week, immersive experience emphasized customer discovery and market validation through a structured, learn-by-doing approach. During this period, a team conducted 30 in-depth interviews with key stakeholders, regulatory bodies, utility companies, and coastal developers to test critical business assumptions and refine the strategy.

Permitting and Regulatory Challenges. For example, one of the most significant findings from the interviews was the complexity of the permitting process. The U.S. Army Corps of Engineers (USACE) and various state-level regulatory bodies emphasized that obtaining permits for innovative solutions like the WEC integrated breakwater can take a minimum of two years. This insight underscored the importance of selecting pre-permitted test sites to streamline the process, allowing for quicker validation and data collection. Engaging early with regulatory bodies emerged as a crucial strategy to mitigate project delays and ensure compliance with environmental regulations.

3D Printing for Sustainable Construction. The interviews also revealed the potential of incorporating 3D printing technology into the project. A concrete 3D printing company offered innovative solutions for producing eco-friendly, irregular caisson structures. These structures are designed to be marine organism-friendly, promoting biodiversity and aligning with environmental regulations. By using fiber-reinforced materials that are resistant to corrosion, this approach provides both structural durability and ecological benefits, making it appealing to environmental agencies and coastal developers. The use of 3D printing was highlighted as a way to reduce construction time and costs while enhancing sustainability.

Utility Companies and Grid Integration. Utility companies stressed the importance of addressing power volatility and grid integration. The utility companies emphasized the need for detailed data from pilot projects to ensure consistent and reliable energy production. This insight reinforced the necessity of a comprehensive demonstration phase that includes thorough data monitoring and analysis. The feedback from utility companies informed the approach to integrating grid-ready solutions and highlighted the importance of stability and efficiency in energy production.

Strategic Locations for Deployment. Several promising locations for initial pilot testing and deployment were identified during the interviews. Some regions face high electricity costs and rely heavily on diesel, making wave energy an attractive, sustainable alternative that could enhance energy resilience and reduce reliance on fossil fuels.

Outcomes from the Flexible Oscillating Water Column. The culmination of the flexible oscillating water column program was a comprehensive presentation that showcased the findings and strategic approach. There were several key findings.

Dual-Purpose Infrastructure. Traditional breakwaters offer limited value as they only serve coastal protection purposes. The WEC integrated breakwater, however, provides a dual-purpose solution by generating renewable energy while protecting coastlines. This dual functionality helps offset maintenance costs and provides economic returns, making the project more appealing to stakeholders and investors.

Eco-Friendly Construction. The potential for using 3D-printed, marine-friendly structures was highlighted as a significant innovation. Unlike traditional smooth-surfaced breakwaters, the textured, irregular design promotes biodiversity by creating habitats for marine organisms. This approach not only aligns with environmental standards but also adds ecological value, which can aid in meeting regulatory requirements.

Permitting and Compliance. The presentation reiterated that engaging with regulatory agencies early and targeting pre-permitted sites is essential for success. By demonstrating that the project aligns with environmental and regulatory standards, the approval process can be streamlined and potential project delays reduced.

Grid Integration and Utility Engagement. The presentation outlined the feedback received from utility companies, emphasizing the importance of pilot data to address power volatility and grid integration challenges. Detailed data collection and monitoring during the demonstration phase are essential to validate the WEC technology's reliability and performance.

### Experimental Analysis of an OWC Integrated Breakwater

In this section, the experiments measuring the performance of an oscillating water column (OWC) breakwater wall at the University of Iowa IHR testing facilities are described. This report documents the preliminary results on the oscillating water column device in a wave flume.

A breakwater wall that consists of repeating units of oscillating water columns can be analyzed hydrodynamically as one oscillating water column unit in a flume or channel as shown in FIG. 48. The flume/channel walls are equivalent to mirror planes that reflect the oscillating water column as an infinite series of units adjacent to each other simulating a very long wall. Projecting walls known as harbor walls were used to help concentrate wave energy to the oscillating water column units especially in coastal water where the energy density is lower than at deep sea. These harbor walls can also assist in increasing the resonant bandwidth characteristics of these cavity resonators. The space in between the oscillating water column units can be used as prime real estate for operations that could benefit by this breakwater wall, such as refrigeration for fisheries, thereby sharing costs across different functions. Hence, a multifunctional breakwater concept is achieved.

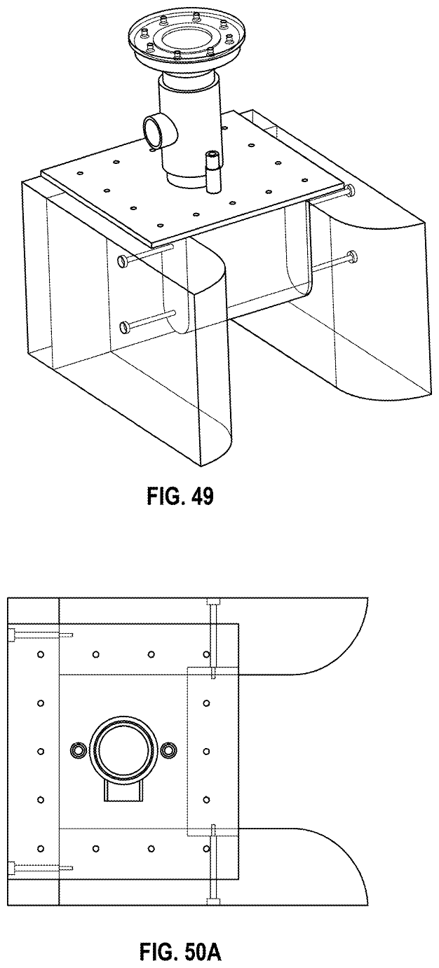

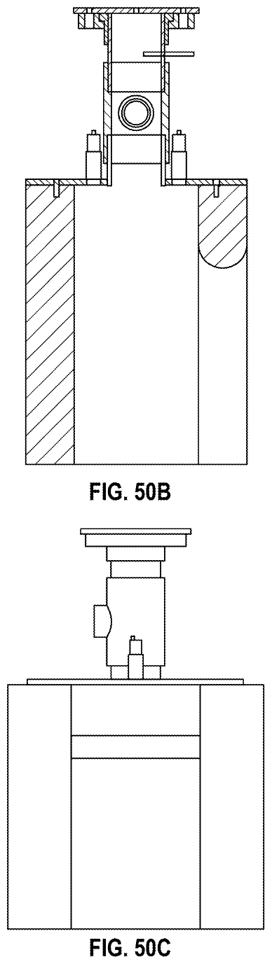

FIG. 49 shows the 3D CAD modular construction of the model that was built (FIG. 48). The model dimension are shown in FIGS. 50A-50C and are as follows oscillating water column Length (OL)=250 mm; oscillating water column width (OW)=300 mm; Lip Width (LW)=100 mm; Lip Depth (LD)=50 mm; Harbor Wall Length (HL)=250 mm; Harbor Half Width (HHW)=150 mm; and Water Depth (WD)=450 mm.

Froude Scaling. Devices were tested in the laboratory test-tank facilities at 1:15 to 1:50 scale model ratios. The model was tested at the University of Iowa wave flume (FIGS. 51A-51B) with a width of 0.6 meters and water depth of 0.45 meters for the flexible oscillating water column tests. The model ratio is 22.22. The most important non-dimensional parameter used to model waves is the Froude number which implies that the time scale is the square root of the model scale. Hence, the time ratio is 4.71.

Modelling Turbine. At model scales, it is impractical to use a turbine to convert wave energy to useful power. Porous membranes are generally used and accepted to represent a linear turbine at the model scale. See e.g., Uddin et al., 2023, “CFD Investigation of a Hybrid Wells Turbine with Passive Flow Control.” Energies, 16(9) 3851. Depending on the turbine, a linear approximation may be applicable. For nonlinear turbines, an orifice plate is adopted with varying hole diameters. In the experiments orifice plates (FIG. 52) are used with varying openings to simulate the turbo-generator loads. The orifice sizes used are 5, 10, 15, 20, 25, 30 mm radius and Fully Closed (FC) and Fully Open (FO).

Air Compressibility. Another important parameter to model in hydrodynamic absorption design is air compressibility. Once Froude criteria is used to model waves it is impossible to satisfy air compressibility scaling at the same time. Froude scaling requires geometric similarity of all dimensions below water interacting with waves. Others have shown that air volume ratio of model to prototype must be scaled to the square rather than the cube as would be expected based on Froude criteria. See e.g., Falcão et al., 2014, “Model-prototype similarity of oscillating-water-column wave energy converters.” Int. J. Mar. Energy, 6 18-34. Only the air chamber volume ratio is scaled to square, all volumes below water where waves interact are scaled to the cube as required in Froude law.

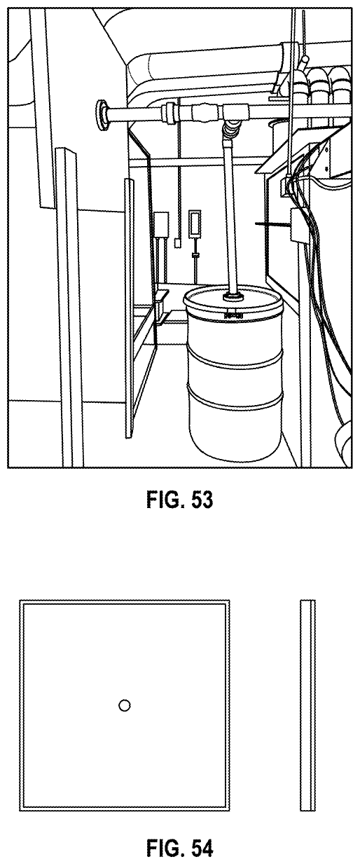

At the 22.22 Model Scale ratio and for the air volume in the model, it was computed that approximately 80 gallons extra air volume are needed to satisfy the air compressibility requirements. The 80 gallon drum connected to the oscillating water column model is shown in FIG. 53.

Base OWC Model. Running the base oscillating water column model for 10 sinusoidal wave frequencies has been completed: 8 damping, totaling 80 experimental runs. This experiment was repeated multiple times to get a good statistical estimate with high confidence. The results were analyzed for errors or anomalies.

Flexible Models. Experimental modeling of a flexible oscillating water column satisfying both the Froude scale for waves, compressibility for air, and elasticity for flexible elements has not been done before. Tests on the flexible oscillating water column were carried out and showed promising results. The elastic membrane box dimensions that were fabricated and that are shown in FIG. 54 can be seen, as fabricated, in the upper left of the photograph in FIG. 53.

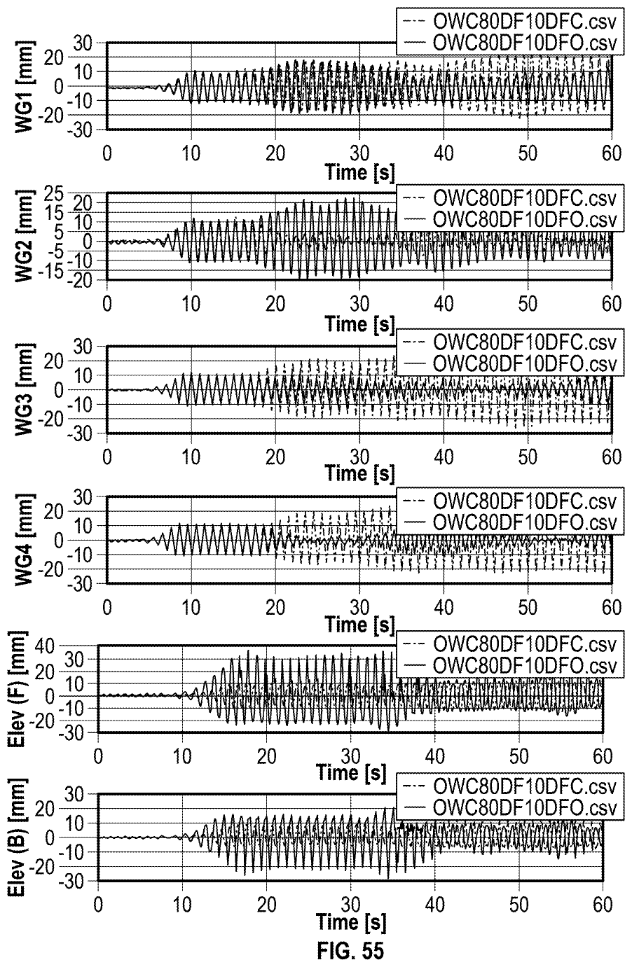

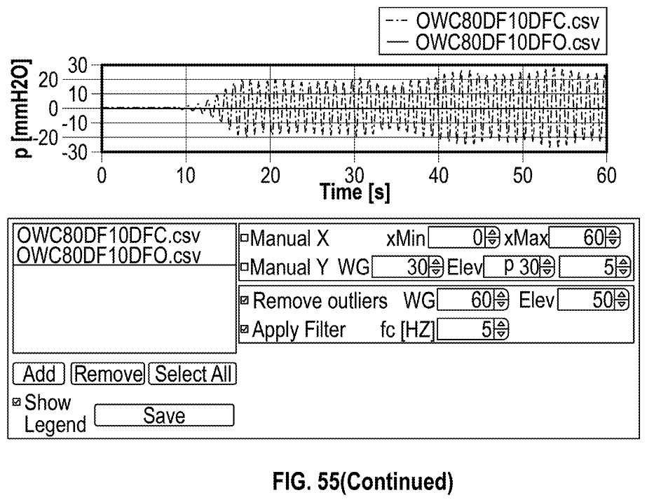

Results. Data preparation for post analysis of the experiments was conducted. A Graphical User Interface (GUI) Tool DATAVIEWER has been developed that can preprocess this data and is shown for a typical experimental run as shown in FIG. 55.

The left four vertically stacked subplots show the four wave measurements in front to the oscillating water column device. These will be used to compute the incident and reflected waves. The red and the blue curves correspond to the Fully Open (FO) and Fully Closed (FC) damping cases respectively. The tool overplotting is a very useful feature to understand the dynamics of the device. The three vertically stacked subplots on the right hand side are the wave measurements inside the oscillating water column in the front (close to lip) and back of oscillating water column and the bottom most plot is the pressure inside the chamber.

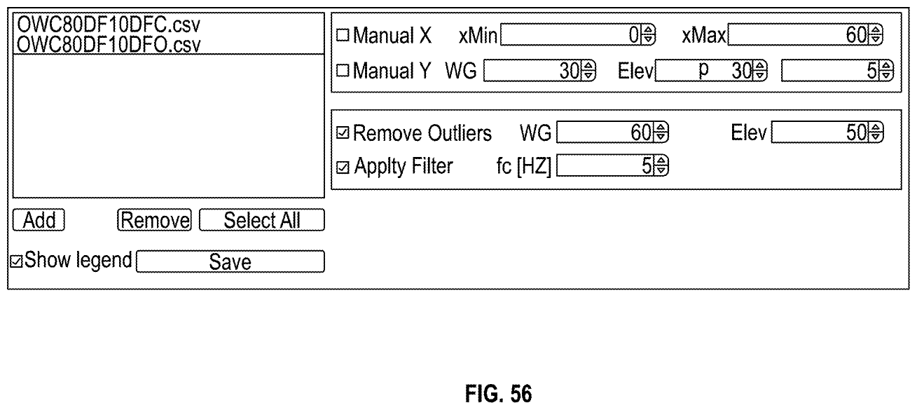

FIG. 56 shows the menu of possible operations. Before the processing of data, data must be preprocessed from the sensors to remove outliers and filter data due to noise. The tool also lets the user select data sets to compare and then save the data for post processing. The X and Y axis can scale and zoom in or out of these plots.

All the data manually using this DATAVIEWER tool is manually reviewed to check for errors or excessive noise. This process will then dictate the post processing routines developed to evaluate and compare the performance of the different models.

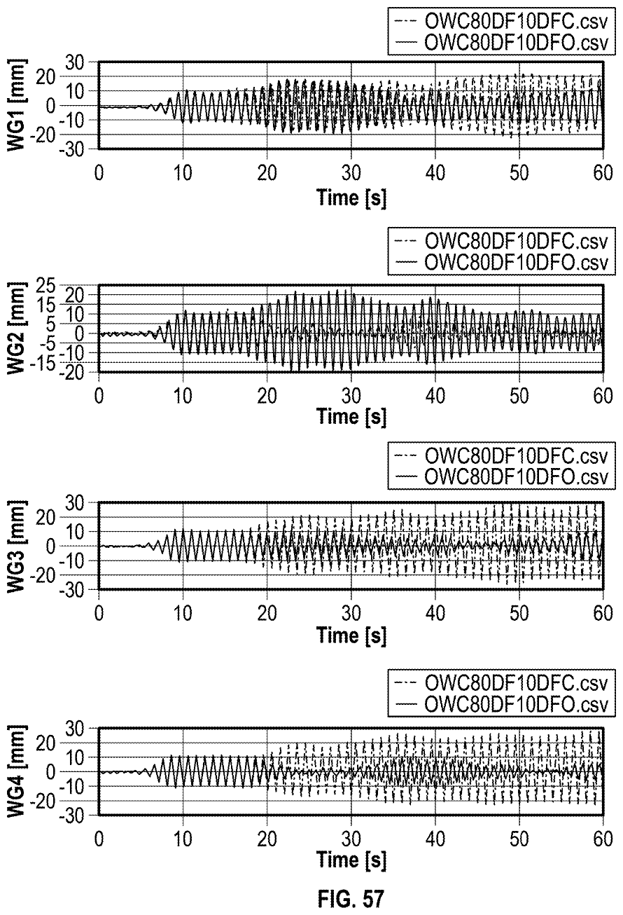

Some of the physics of these measurements are explained herein. FIG. 57 plots the 4-probe measurements from the probes midway between the oscillating water column device and wavemaker as depicted in FIGS. 51A-51B. The probe spacing is determined to be able to compute the incident and reflected waves as proposed in the present disclosure.

One can observe from FIG. 57 in the first 10 seconds time block, the waves from the wavemaker are propagating to the wave probes. This is the transient build up zone. Thereafter for about five waves, there is a steady state response. After that, the waves from the oscillating water column reach the wave probes and waxing and waning of the signal can be seen indicating two waves from either direction interfering to produce this resultant wave. Towards the end, even more buildup of wave amplitude when the reflected waves reach the wave maker and get pushed back at the wave probes again.

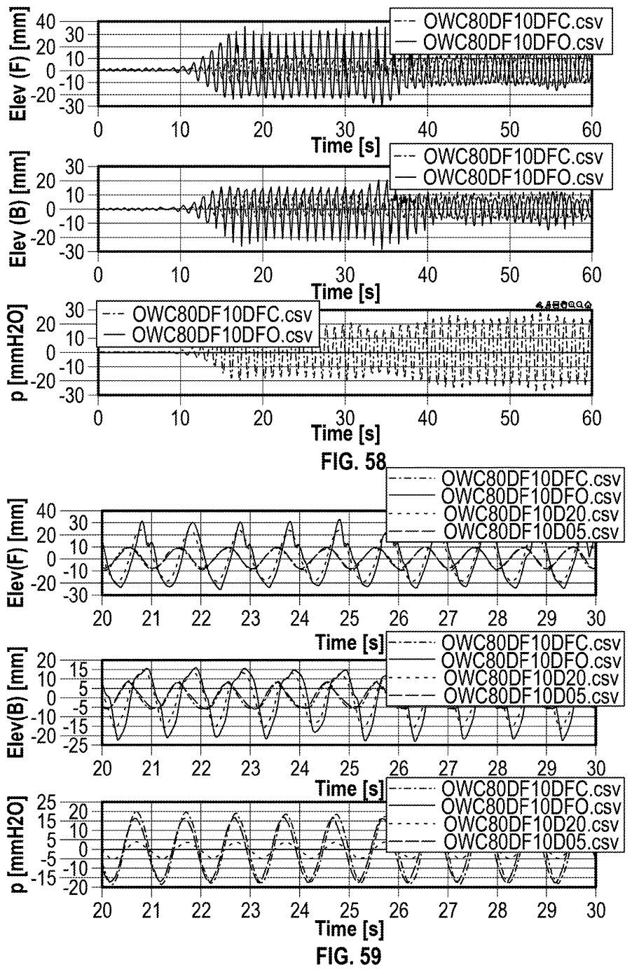

FIG. 58 shows the measurements inside the oscillating water column. The measurements from top to bottom are elevation in the front inside the oscillating water column close to the lip, the elevation close to the back wall inside the oscillating water column and the pressure inside the oscillating water column. The elevations inside follow the same pa Dern of the wave probes, a transient, then a steady state and then the re-reflected phase. The bottommost pressure signal has similar behavior but not as obvious as the elevation signals.

The red and blue plots show the differences between Fully Open (FO) and Fully Closed (FC) damping applied on the OWC. The red FO case for pressure is zero as expected. The FO elevations are maximum as there is no damping. In between these extreme damping there is an optimal damping where power will be maximized. Power is the product of pressure and flowrate. Flowrate can be computed by differentiating the elevation to get velocity and multiplying by oscillating water column area.

FIG. 59 shows the overplot of four damping cases. The Fully Open (FO) and 20 mm Radius Orifice are close to one another. The Fully Closed (FC) and 5 mm Radius orifice are close together as expected. These intuitive logic checks show the indirect ways the data integrity can be checked. This visible phase shift educates the response of the device and can drive data evaluation algorithms.

From the foregoing, it can be seen that the present disclosure accomplishes at least all of the stated objectives.

### LIST OF REFERENCE CHARACTERS

The following table of reference characters and descriptors are not exhaustive, nor limiting, and include reasonable equivalents. If possible, elements identified by a reference character below and/or those elements which are near ubiquitous within the art can replace or supplement any element identified by another reference character.

TABLE 1
List of Reference Characters

| | |
|---|---|
| 100 | oscillating water column |
| 102 | air flow in-take |
| 104 | electric generator |
| 106 | rotor |
| 108A | wave trough |
| 108B | wave crest |
| 110A | falling water column |
| 110B | rising water column |
| 200 | breakwater |
| 202 | generator |
| 204 | turbine |
| 206 | butterfly valve |
| 208 | dome |
| 210 | oscillating water column |
| 212 | back wall |
| 214 | lip wall |
| 216 | sand filling |
| 218 | still water level |
| 300 | flexible oscillating water column |
| 302 | flexible element (also referred to herein as flexible material |
| | and flexible membrane) |
| 304 | rigid structure of oscillating water column |
| 306 | air chamber |
| 308 | turbine |
| 309 | valve |
| 310 | oscillating water |
| 312 | front wall |
| 314 | curved subwall |
| 316 | center wall |
| 318 | relief |
| 320 | bottom side of top surface |
| 322 | rear edge |
| 324 | top side of top surface |
| 400 | numerical wave tank |
| 402 | internal fluid domain |
| 404 | surrounding fluid domain |
| 406 | deform face out |
| 408 | deform face in |
| 410 | velocity inlet |
| 412 | pressure outlet |
| 414 | symmetry |
| 416 | free surface |
| 500 | towing tank |
| 502 | beach |
| 504 | planar motion mechanism (PMM) carriage |
| 506 | instrumented drive carriage |
| 508 | wave dampers |
| 510 | wavemaker |
| 600 | breakwater wall |
| 602 | oscillating water column unit |
| 604 | flume |
| 606 | flume/channel wall |
| 608 | harbor wall |
| 610 | waves |

### Glossary

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order (e.g., first, second, third), a position, and/or an orientation are not limiting and are only referenced according to the views presented.

When an element is referred to as being “connected,” “coupled,” “mated,” “attached,” “fixed,” etc. to another element, the element can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.). Similarly, terms such as (i) “communicatively connected” or (ii) “fluidly connected” include (i) all variations of information exchange and routing between two electronic devices, including intermediary devices, networks, etc., connected wirelessly or not and (ii) all variations of fluid exchange and routing between two fluidic bodies, including intermediary fluid paths, flows, etc., connected indirectly or not.

The “invention” is not intended to refer to any single embodiment of the particular invention but encompass all possible embodiments as described in the specification and the claims. The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

What is claimed is:

1. A flexible oscillating water column (300/602) comprising:
an oscillating water column comprising a rigid structure (304); and
a flexible material (302) that has a different frequency response to the rigid structure (304) of the oscillating water column so that the flexible oscillating water column (300) is multi-resonant; and
advanced controls that convert energy content in ocean waves to electric power and have a flexibility to tune the device depending on changes in wave climate across seasons.

2. The flexible oscillating water column (300/602) of claim 1, wherein the flexible oscillating water column (300/602) is integrated into a coastal structure.

3. The flexible oscillating water column (300/602) of claim 2, wherein the costal structure is a breakwater (200).

4. The flexible oscillating water column (300/602) of claim 3, wherein the flexible material (302) is installed inside the breakwater (200).

5. The flexible oscillating water column (300/602) of claim 3, wherein the breakwater (200) is anchored in place with a support structure filled with sand (216).

6. The flexible oscillating water column (300/602) of claim 3, wherein a majority of the support structure is located below a still water level (218).

7. The flexible oscillating water column (300/602) of claim 2, wherein the costal structure comprises a concrete caisson.

8. The flexible oscillating water column (300/602) of claim 1, wherein the rigid structure (304) is attached to the flexible material (302) so as to permit z-directional movement therebetween.

9. The flexible oscillating water column (300/602) of claim 8, wherein the breakwater (200) is a harbor wall (608) built along a coast of a body of water that creates a sheltered zone close to the coast.

10. The flexible oscillating water column (300/602) of claim 9, wherein the harbor wall (608) comprises a port for shipping and transporting goods.

11. The flexible oscillating water column (300/602) of claim 1, wherein the flexible material capable of deforming while storing a stiffness energy.

12. The flexible oscillating water column (300/602) of claim 11, wherein deformation is controlled, at least in part, by distributed piezoelectric actuators and harvesters.

13. The flexible oscillating water column (300/602) of claim 1, wherein the flexible material (302) comprises a Poisson's ratio of approximately ν=0.3.

14. The flexible oscillating water column (300/602) of claim 1, wherein the advanced controls comprise phase control.

15. The flexible oscillating water column (300/602) of claim 1, wherein the flexible material (302) places a rubber membrane in an air flow chamber (306) of the oscillating water column (300/602).

16. The flexible oscillating water column (300/602) of claim 1, further comprising one or more valves (206/309) capable of shutting down the flexible oscillating water column so as to mitigate a risk of rough waters.

17. The flexible oscillating water column (300/602) of claim 16, wherein the one or more valves (206/309) comprises a butterfly valve (206).

18. The flexible oscillating water column (300/602) of claim 1, wherein the flexible material (302) is placed either in parallel with the air flow, thereby acting as elastic storage to prevent water hammer and shock loads.

19. The flexible oscillating water column (300/602) of claim 1, further comprising a power take-off unit in the oscillating water column (304) that includes the generator (202/308) and the advanced controls, wherein the power take-off outputs the electric power and the control force on a shaft of the generator (202/308).

20. The flexible oscillating water column (300/602) of claim 19, wherein the power take-off unit comprises a unidirectional power flow capability.
